(19) United States
(12) Patent Application Publication
(10) Pub. No.: US 2019/0163113 A1
(43) Pub. Date: May 30, 2019

(54) IMAGE FORMING SYSTEM, CONTROL METHOD, AND CONTROL PROGRAM

(71) Applicant: Konica Minolta Inc., Tokyo (JP)

(72) Inventor: Hiroyuki Konishi, Tokyo (JP)

(21) Appl. No.: 16/172,029

(22) Filed: Oct. 26, 2018

(30) Foreign Application Priority Data
Nov. 29, 2017 (JP) 2017-229223

(51) Int. Cl. G03G 15/00

(52) U.S. Cl. CPC G03G 15/70; G03G 2215/00552; G03G 15/65

(57) ABSTRACT

An image forming system includes: a sheet conveyor which conveys a sheet along the conveyance path; an image former which forms an image on the sheet; a sheet discharger which discharges the sheet to an outside; and a hardware processor that determines, in a case where abnormality occurs in sheet conveyance on the conveyance path, whether a first residual sheet is included in the sheets stopped at the stop points, and executes first automatic purge processing of conveying and discharging the first residual sheet to the sheet discharger before the jammed sheet is removed, and second automatic purge processing of discharging a second residual sheet different from the first residual sheet, of the sheets stopped at the stop points, to the sheet discharger, after the jammed sheet is removed, according to a determination result of the hardware processor.

The entire disclosure of Japanese patent Application No. 2017-229223, filed on Nov. 29, 2017, is incorporated herein by reference in its entirety.

### BACKGROUND

### Technological Field

The present invention relates to an image forming system, a control method, and a control program.

### Description of the Related Art

A technology called automatic purge to automatically discharging residual sheets in a conveyance path is known. The automatic purge is performed after a sheet causing a jam (hereinafter referred to as “jammed sheet”) is removed by a user when abnormality (hereinafter referred as jam) has occurred in conveyance of sheets in an image forming system. In conventional automatic purge processing, sheets being conveyed on an upstream side in the conveyance paths viewed from the jammed sheet are stopped at appropriate stop points, and the sheets stopped at the stop points are sequentially discharged to the outside after the jammed sheet is removed by the user. By performing the automatic purge processing, time and effort of the user in an operation of removing the jammed sheet and the residual sheets in the conveyance path (hereinafter referred to as “jam processing”) can be reduced.

However, the residual sheets scheduled for the automatic purge processing may become an obstacle when the jammed sheet is removed, depending on occurrence situation of the jam. That is, in a case where the removal of the jammed sheet and the residual sheets scheduled for the automatic purge processing are in a conflict relationship, this conflict relationship needs to be eliminated by some method before the jammed sheet is removed. However, increasing the number of steps of the jam processing or increasing the number of sheets to be removed by the user to eliminate the conflict relationship lead to an increase in burden on the user and are therefore not desirable.

In this connection, JP 2008-52125 A discloses a technology of automatically purging residual sheets before removal of a jammed sheet when there is a residual sheet conveyable path, and automatically purging the residual sheets after removal of the jammed sheet when there is no conveyable path in a double-sided image forming apparatus that performs interleaf operation.

However, in the technology in JP 2008-52125 A, the conflict between the removal of the jammed sheet and the residual sheets scheduled for the automatic purge processing is not taken into consideration. Therefore, the number of steps of the jam processing may increase in a case where the conflict between the removal of the jammed sheet and the residual sheets scheduled for the automatic purge processing occurs.

### SUMMARY

The present invention has been made in view of the above problem. Therefore, an object of the present invention is to provide an image forming system that suppresses an increase in the number of steps of jam processing and an increase in the number of sheets that should be removed by a user in the jam processing while avoiding a conflict between removal of a jammed sheet and a residual sheet scheduled for automatic purge processing.

To achieve the abovementioned object, according to an aspect of the present invention, an image forming system reflecting one aspect of the present invention comprises: a sheet conveyor including a conveyance path and which conveys a sheet along the conveyance path; an image former provided on the conveyance path and which forms an image on the sheet; a sheet discharger provided on a downstream side in a sheet conveyance direction of the image former and which discharges the sheet to an outside; and a hardware processor that determines, in a case where abnormality occurs in sheet conveyance on the conveyance path, after stop processing of stopping sheets other than a jammed sheet at predetermined stop points according to conveyance positions at the occurrence of the abnormality, the jammed sheet being a cause of the abnormality in the conveyance path, is executed, whether a first residual sheet that needs to be moved before the jammed sheet is removed is included in a plurality of the sheets stopped at the stop points, and executes first automatic purge processing of conveying and discharging the first residual sheet to the sheet discharger before the jammed sheet is removed, and second automatic purge processing of discharging a second residual sheet different from the first residual sheet, of the sheets stopped at the stop points, to the sheet discharger, after the jammed sheet is removed, according to a determination result of the hardware processor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of an image forming system according to an embodiment;

FIG. 2 is a schematic block diagram illustrating a hardware configuration of the image forming system illustrated in FIG. 1;

FIG. 3 is a diagram schematically illustrating stop points in the image forming system illustrated in FIG. 1;

FIG. 4A is a diagram schematically illustrating an ADU frame of the image forming apparatus illustrated in FIG. 1;

FIG. 4B is a diagram schematically illustrating an upper tray and a horizontal conveyor of first and second sheet feeding apparatuses illustrated in FIG. 1;

FIG. 5A is a flowchart exemplarily illustrating an image forming system control method according to an embodiment;

FIG. 5B is a subroutine flowchart exemplarily illustrating processing of step S111 in FIG. 5A;

FIG. 6 is a subroutine flowchart exemplarily illustrating processing of step S110 in FIG. 5A;

FIG. 7A is a diagram for describing a position of a jammed sheet in first residual sheet presence/absence determination;

FIG. 7B is a diagram for describing a position of a jammed sheet in the first residual sheet presence/absence determination;

FIG. 8 is a subroutine flowchart exemplarily illustrating processing of step S203 in FIG. 5B;

FIG. 9A is a schematic diagram exemplarily illustrating positions of sheets at the time of occurrence of a jam in a first example;

FIG. 9B is a schematic diagram exemplarily illustrating positions of sheets after stop processing in the first example;

FIG. 9C is a schematic diagram exemplarily illustrating a case in which a residual sheet is stopped over a conveyance path inside and outside the ADU frame of the image forming apparatus in the first example;

FIG. 9D is a schematic diagram exemplarily illustrating positions of sheets after first automatic purge processing is performed in the first example;

FIG. 9E is a schematic diagram exemplarily illustrating positions of sheets after a jammed sheet is removed in the first example;

FIG. 9F is a schematic diagram exemplarily illustrating positions of sheets after second automatic purge processing is performed in the first example;

FIG. 10A is a schematic diagram exemplarily illustrating positions of sheets at the time of occurrence of a jam in a second example;

FIG. 10B is a schematic diagram exemplarily illustrating positions of sheets after stop processing in the second example;

FIG. 10C is a schematic diagram exemplarily illustrating positions of sheets after a first residual sheet is moved to a downstream stop point in the second example;

FIG. 10D is a schematic diagram exemplarily illustrating positions of sheets after a jammed sheet is removed in the second example;

FIG. 10E is a schematic diagram exemplarily illustrating positions of sheets after third automatic purge processing is performed in the second example;

FIG. 11A is a schematic diagram exemplarily illustrating positions of sheets at the time of occurrence of a jam in a third example;

FIG. 11B is a schematic diagram exemplarily illustrating positions of sheets after a jammed sheet and a first residual sheet are removed in the third example;

FIG. 11C is a schematic diagram exemplarily illustrating positions of sheets after fourth automatic purge processing is performed in the third example;

FIG. 12A is a schematic diagram exemplarily illustrating positions of sheets at the time of occurrence of a jam in a fourth example;

FIG. 12B is a schematic diagram exemplarily illustrating positions of sheets after stop processing in the fourth example;

FIG. 12C is a schematic diagram exemplarily illustrating a case in which a residual sheet is stopped at an outlet of an upper tray of a second sheet feeding apparatus in the fourth example;

FIG. 12D is a schematic diagram exemplarily illustrating positions of sheets after first automatic purge processing is performed in the fourth example;

FIG. 12E is a schematic diagram exemplarily illustrating positions of sheets after a jammed sheet is removed in the fourth example;

FIG. 12F is a schematic diagram exemplarily illustrating positions of sheets after second automatic purge processing is performed in the fourth example;

FIG. 13A is a schematic diagram exemplarily illustrating positions of sheets after a first residual sheet is moved to a downstream stop point in a fifth example;

FIG. 13B is a schematic diagram exemplarily illustrating positions of sheets after a jammed sheet is removed in the fifth example;

FIG. 13C is a schematic diagram exemplarily illustrating positions of sheets after third automatic purge processing is performed in the fifth example;

FIG. 14A is a schematic diagram exemplarily illustrating an arrangement order of tab sheets in a sixth example;

FIG. 14B is a schematic diagram exemplarily illustrating positions of sheets at the time of occurrence of a jam in the sixth example;

FIG. 14C is a schematic diagram exemplarily illustrating positions of sheets after stop processing in the sixth example;

FIG. 14D is a schematic diagram exemplarily illustrating a sheet feeding order of tab sheets stored in an upper tray of an image forming apparatus in the sixth example;

FIG. 14E is a schematic diagram exemplarily illustrating positions of sheets after first automatic purge processing is performed in the sixth example;

FIG. 14F is a schematic diagram exemplarily illustrating positions of sheets after a jammed sheet is removed in the sixth example;

FIG. 14G is a schematic diagram exemplarily illustrating a tab sheet reset in the upper tray of the image forming apparatus in the sixth example;

FIG. 14H is a schematic diagram exemplarily illustrating positions of sheets after second automatic purge processing is performed in the sixth example;

FIG. 15A is a schematic diagram exemplarily illustrating positions of sheets after stop processing in a seventh example;

FIG. 15B is a schematic diagram exemplarily illustrating positions of sheets after a first residual sheet is moved to a downstream stop point in the seventh example;

FIG. 15C is a schematic diagram exemplarily illustrating positions of sheets after third automatic purge processing is performed in the seventh example;

FIG. 16A is a schematic diagram exemplarily illustrating positions of sheets at the time of occurrence of a jam in an eighth example;

FIG. 16B is a schematic diagram exemplarily illustrating positions of sheets after stop processing in the eighth example;

FIG. 16C is a schematic diagram exemplarily illustrating positions of sheets after a jammed sheet and a first residual sheet are removed in the eighth example; and

FIG. 16D is a schematic diagram exemplarily illustrating positions of sheets after fourth automatic purge processing is performed in the eighth example.

### DETAILED DESCRIPTION OF EMBODIMENTS

Hereinafter, one or more embodiments of an image forming system of the present invention will be described with reference to the drawings. However, the scope of the invention is not limited to the disclosed embodiments. Note that, in the drawings, the same reference numerals are used for the same members. Further, the dimensional ratios of the drawings are exaggerated for convenience of description and may be different from the actual ratios.

### Embodiment

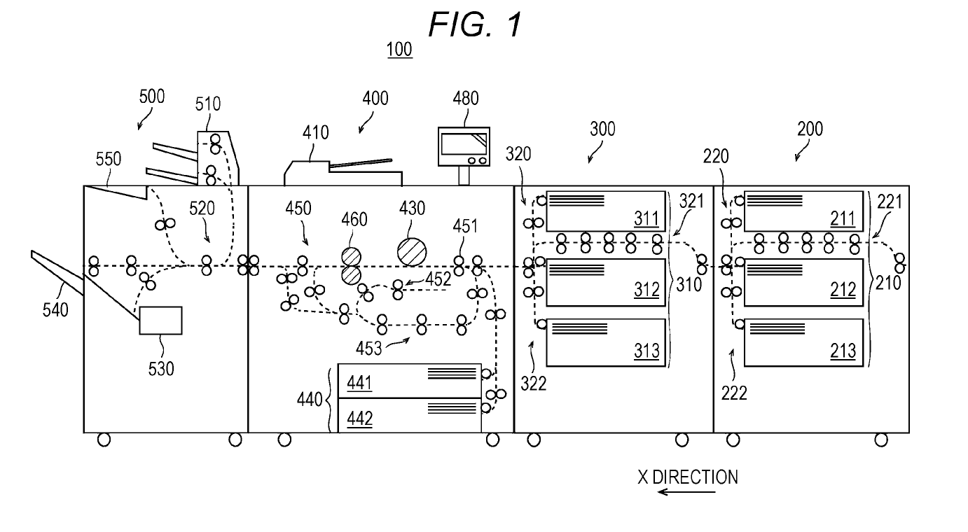

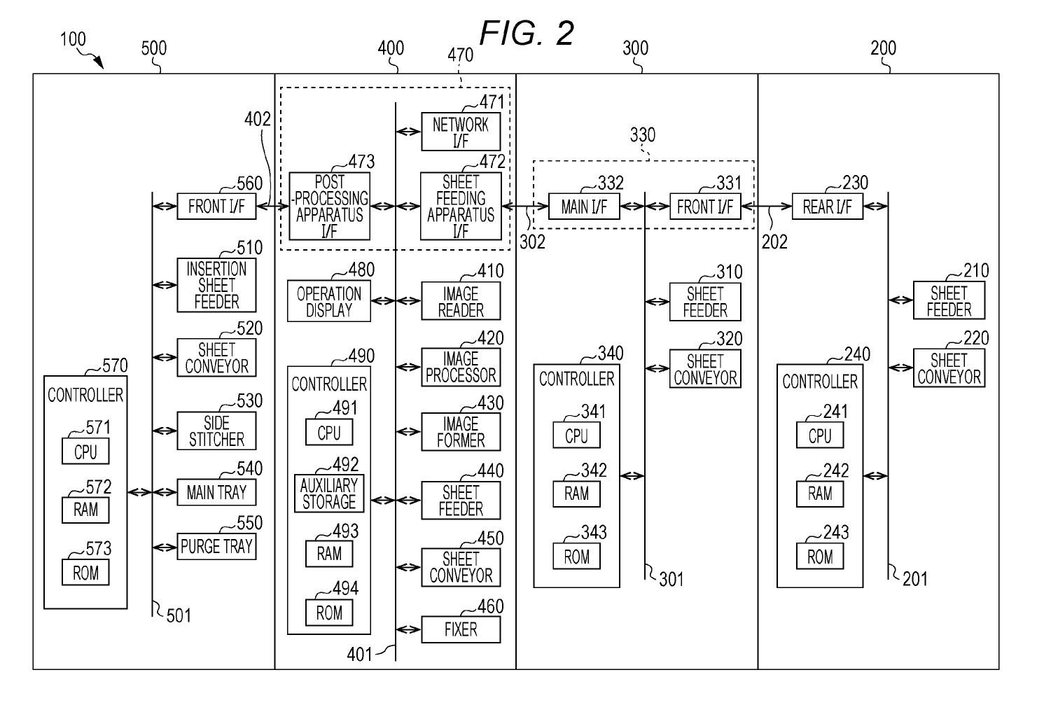

FIG. 1 is a diagram illustrating a schematic configuration of an image forming system 100 according to an embodiment, and FIG. 2 is a schematic block diagram illustrating a hardware configuration of the image forming system 100 illustrated in FIG. 1.

<Image Forming System 100>

As illustrated in FIG. 1 and FIG. 2, the image forming system 100 of the present embodiment includes a first sheet feeding apparatus 200, a second sheet feeding apparatus 300, an image forming apparatus 400, and a post-processing apparatus 500, which are connected in series along an X direction (sheet conveyance direction). Note that the configuration of the image forming system 100 illustrated in FIGS. 1 and 2 is an example, and the type and the number of apparatuses included in the image forming system 100 are not limited to the example illustrated in FIGS. 1 and 2.

<First Sheet Feeding Apparatus 200>

The first sheet feeding apparatus 200 supplies a sheet to the second sheet feeding apparatus 300 according to an instruction from the image forming apparatus 400. The first sheet feeding apparatus 200 is disposed at the most upstream in the image forming system 100, and includes a sheet feeder 210, a sheet conveyor 220, a rear I/F 230, and a controller 240. These constituent elements are communicatively connected to one another via an internal bus 201.

The sheet feeder 210 supplies a sheet as a recording material to be used for printing. The sheet feeder 210 includes, for example, an upper tray 211, a middle tray 212, and a lower tray 213, and sheets of different sizes such as A4 size and A3 size, or tab sheets can be stored in the trays.

The sheet conveyor 220 includes a horizontal conveyor 221 and a vertical conveyor 222. The horizontal conveyor 221 includes a conveyance path that substantially horizontally extends and a plurality of conveyance rollers, and conveys a sheet supplied from an external device or a manual feed tray along the conveyance path and supplies the sheet to the second sheet feeding apparatus 300. Further, the vertical conveyor 222 includes a conveyance path that substantially vertically extends and a plurality of conveyance rollers, and conveys the sheet supplied from the sheet feeder 210 along the conveyance path and supplies the sheet to the second sheet feeding apparatus 300.

In addition, the sheet conveyor 220 includes a sheet detection sensor (not illustrated) installed in the conveyance path. A plurality of the sheet detection sensors can be arranged to detect conveyance of the sheet at a plurality of positions such as just before branching of the conveyance path. A detection result of the sheet detection sensor is transmitted to the image forming apparatus 400.

The rear I/F 230 is communicatively connected to the second sheet feeding apparatus 300 via a communication line 202, and transmits and receives data.

The controller 240 controls the sheet feeder 210, the sheet conveyor 220, and the rear I/F 230. The controller 240 includes a central processing unit (CPU) 241, a read only memory (ROM) 242, a random access memory (RAM) 243, and the like.

The CPU 241 executes a control program for the first sheet feeding apparatus to realize various functions. The RAM 242 stores a calculation result, a processing result, and the like of the CPU 241. The ROM 243 stores the above control program, various parameters, and the like.

<Second Sheet Feeding Apparatus 300>

The second sheet feeding apparatus 300 supplies the sheet to the image forming apparatus 400 according to an instruction from the image forming apparatus 400. The second sheet feeding apparatus 300 is disposed between the first sheet feeding apparatus 200 and the image forming apparatus 400, and includes a sheet feeder 310, a sheet conveyor 320, a communicator 330, and a controller 340. These constituent elements are communicatively connected to one another via an internal bus 301.

The sheet feeder 310 supplies a sheet as a recording material to be used for printing. The sheet feeder 310 includes, for example, an upper tray 311, a middle tray 312, and a lower tray 313, and sheets of different sizes such as A4 size and A3 size, or tab sheets can be stored in the trays.

The sheet conveyor 320 includes a horizontal conveyor 321 and a vertical conveyor 322. The horizontal conveyor 321 includes a conveyance path that substantially horizontally extends and a plurality of conveyance rollers, and conveys the sheet supplied from the first sheet feeding apparatus 200 along the conveyance path and supplies the sheet to the image forming apparatus 400. Further, the vertical conveyor 322 includes a conveyance path that substantially vertically extends and a plurality of conveyance rollers, and conveys the sheet supplied from the sheet feeder 310 along the conveyance path and supplies the sheet to the image forming apparatus 400.

In addition, the sheet conveyor 320 includes a sheet detection sensor (not illustrated) installed in the conveyance path. A plurality of the sheet detection sensors can be arranged to detect conveyance of the sheet at a plurality of positions such as just before branching of the conveyance path. A detection result of the sheet detection sensor is transmitted to the image forming apparatus 400.

The communicator 330 includes a front I/F 331 and a main I/F 332. The front I/F 331 is communicatively connected to the rear I/F 230 of the first sheet feeding apparatus 200 via the communication line 202, and transmits and receives data. The main I/F 332 is communicatively connected to the image forming apparatus 400 via a communication line 302, and transmits and receives data.

The controller 340 controls the sheet feeder 310, the sheet conveyor 320, and the communicator 330. The controller 340 includes a CPU 341, a RAM 342, and a ROM 343.

The CPU 341 executes a control program for the second sheet feeding apparatus to realize various functions. The RAM 342 stores a calculation result, a processing result, and the like of the CPU 341. The ROM 343 stores the above control program, various parameters, and the like.

<Image Forming Apparatus 400>

The image forming apparatus 400 reads an image from a document and forms (prints) the read image on a sheet. Further, the image forming apparatus 400 receives a print job including print data and print setting data in a page description language (PDL) format from an external client terminal through a network, and forms an image on a sheet on the basis of the received print job. The client terminal may be, for example, a personal computer, a tablet terminal, or a smartphone.

The image forming apparatus 400 is disposed between the second sheet feeding apparatus 300 and the post-processing apparatus 500, and includes an image reader 410, an image processor 420, an image former 430, a sheet feeder 440, a sheet conveyor 450, a fixer 460, a communicator 470, an operation display 480, and a controller 490. These constituent elements are communicatively connected to one another via an internal bus 401.

The image reader 410 includes an optical system including a mirror, a lens, and the like, and a reading sensor. The image reader 410 reads a document placed on a reading surface or a document conveyed by an auto document feeder (ADF) and outputs an image signal.

The image processor 420 performs various types of image processing for the image signal received from the image reader 410, and generates print image data. Further, the image processor 420 generates the print image data on the basis of print setting information and the print data included in the print job received by the communicator 470. The generated print image data is transmitted to the image former 430.

The image former 430 forms an image on a sheet on the basis of the print image data, using a known image forming process such as an electrophotographic method including charging, exposure, development, and transfer steps.

The image former 430 includes a photosensitive drum as an image carrier, and a charger, an optical writer, a developing device, and a transferer disposed around the photosensitive drum.

The photosensitive drum rotates at a predetermined speed by a drum motor (not illustrated). The charger includes a corona discharge electrode disposed around the photosensitive drum, and charges a surface of the photosensitive drum by generated ions. The optical writer incorporates a scanning optical device and exposes the charged photosensitive drum on the basis of input print image data to lower a potential of the exposed portion and form a charged pattern (electrostatic latent image) corresponding to the print image data. The developing device develops the formed electrostatic latent image, visualizes the image with a toner, and forms a toner image. The transferer transfers the toner image on the photosensitive drum to the sheet.

The sheet feeder 440 supplies the sheet as a recording material to the image former 430. The sheet feeder 440 includes an upper tray 441 and a lower tray 442, and sheets of different sizes such as A4 size and A3 size, or tab sheets can be stored in the trays.

The sheet conveyor 450 conveys the sheet in the image forming apparatus 400. The sheet conveyor 450 includes a conveyance path, a plurality of conveyance rollers including a resist roller pair 451, and a sheet detection sensor (not illustrated) installed in the conveyance path. A plurality of the sheet detection sensors can be arranged to detect conveyance of the sheet at a plurality of positions such as just before branching of the conveyance path. A detection result of the sheet detection sensor is transmitted to the controller 490.

Further, the sheet conveyor 450 includes a sheet inverter 452 and a circulation conveyor 453, and can invert the sheet to which fixation has been made or can form images on both sides of the sheet.

The sheet supplied from the second sheet feeding apparatus 300 or the sheet feeder 440 is conveyed to the image former 430 along the conveyance path. The sheet is synchronized with the toner image formed on the photosensitive drum in the resist roller pair 451, and timing to be conveyed to the transferer is controlled. The sheet on which the toner image has been transferred by the transferer is conveyed to the fixer 460.

The fixer 460 fixes the toner image formed on the sheet. The fixer 460 includes a hollow heating roller in which a heater is disposed, and a pressure roller facing the heating roller. The heating roller and the pressure roller are controlled to a predetermined temperature (for example, 100° C. or higher) by a heater, and apply heating/pressure processing to the sheet to fix the toner image.

The sheet on which the image has been fixed is supplied to the post-processing apparatus 500 through a sheet discharger (not illustrated).

The communicator 470 includes a network I/F 471, a sheet feeding apparatus I/F 472, and a post-processing apparatus I/F 473. The network I/F 471 is connected to a client terminal such as a personal computer via a network, and transmits and receives data such as a print job.

The sheet feeding apparatus I/F 472 is communicatively connected to the main I/F 332 of the second sheet feeding apparatus 300 via the communication line 302, and transmits and receives data. The post-processing apparatus I/F 473 is communicatively connected to the post-processing apparatus 500 via a communication line 402, and transmits and receives data.

The operation display 480 includes an inputter and an outputter. The inputter includes, for example, a keyboard or a touch panel, and is used by a user to input various instructions (inputs) such as a character input, various settings, and a start instruction. In the present embodiment, the user can set permission/prohibition of execution of first automatic purge processing described below through the inputter. Further, the outputter includes a display and is used for presenting, to the user, a device configuration, an execution status of a print job, occurrence of abnormality (jam) in sheet conveyance, occurrence of an error, currently changeable setting, and the like.

The controller 490 controls the image reader 410, the image processor 420, the image former 430, the sheet feeder 440, the sheet conveyor 450, the fixer 460, the communicator 470, and the operation display 480. The controller 490 includes a CPU 491, an auxiliary storage device 492, a RAM 493, and a ROM 494.

The CPU 491 executes a control program for the image forming apparatus. The control program is stored in the auxiliary storage device 492 and loaded into the RAM 493 when executed by the CPU 491. The auxiliary storage device 492 includes a large-capacity storage device such as a hard disk drive or a flash memory. The RAM 493 stores calculation associated with the execution of the CPU 491, jam information, and the like. The jam information is information regarding a sheet (jammed sheet) causing conveyance abnormality that has occurred in the image forming system 100. The jam information includes, for example, the position of the jammed sheet in the conveyance path of each apparatus. The ROM 494 stores various parameters, various programs, and the like.

The CPU 491 executes the above control program to realize various functions. For example, the controller 490 functions as a jam detector together with the sheet detection sensor of each apparatus, and detects a jam in the conveyance path of each apparatus. Further, the controller 490 functions as a purge controller that controls execution of residual sheet automatic purge processing. Further, in the present embodiment, the controller 490 functions as a residual sheet determiner. The residual sheet determiner determines whether there is a residual sheet that needs to be moved on the conveyance path of each apparatus other than the jammed sheet before the jammed sheet is removed.

<Post-Processing Apparatus 500>

The post-processing apparatus 500 conveys or post-processes the sheet supplied from the image forming apparatus 400 according to an instruction from the image forming apparatus 400, and discharges the sheet to the outside of the image forming system 100. The post-processing apparatus 500 is disposed at the most downstream in the image forming system 100, and includes an insertion sheet feeder 510, a sheet conveyor 520, a side stitcher 530, a main tray 540, a purge tray 550, a front I/F 560, and a controller 570. These constituent elements are communicatively connected to one another via an internal bus 501.

The insertion sheet feeder 510 includes one or a plurality of sheet feed trays. For example, printed sheets, colored sheets, or the like are loaded on the sheet feed tray of the insertion sheet feeder 510, and these are used as, for example, a front cover or an insertion sheet of chapters of a printed bundle. The sheets placed on the sheet feed tray are fed at predetermined timing on the basis of the print setting information.

The sheet conveyor 520 includes a conveyance path and a plurality of conveyance rollers, and conveys the sheet supplied from the image forming apparatus 400 along the conveyance path. Further, the sheet conveyor 520 conveys the sheet supplied from the insertion sheet feeder 510 along the conveyance path. Further, the sheet conveyor 520 conveys a booklet stitched in the side stitcher 530 to the main tray 540.

In addition, the sheet conveyor 520 includes a sheet detection sensor (not illustrated) installed in the conveyance path. A plurality of the sheet detection sensors can be arranged to detect conveyance of the sheet at a plurality of positions such as just before branching of the conveyance path. A detection result of the sheet detection sensor is transmitted to the image forming apparatus 400.

The side stitcher 530 includes a stacker that accumulates sheets and a stapler that staples a bundle of sheets. The side stitcher 530 staples an end of the bundle of sheets to stitch the bundle of sheets to create a booklet.

The main tray 540 functions as a sheet discharger and discharges an effective sheet among the sheets conveyed by the sheet conveyor 520. The purge tray 550 functions as a sheet discharger and discharges an ineffective sheet among the sheets conveyed by the sheet conveyor 520.

The front I/F 560 is communicatively connected to the post-processing apparatus I/F 473 of the image forming apparatus 400 via the communication line 402, and transmits and receives data.

The controller 570 controls the insertion sheet feeder 510, the sheet conveyor 520, the side stitcher 530, the main tray 540, the purge tray 550, and the front I/F 560. The controller 570 includes a CPU 571, a RAM 572, and a ROM 573.

The CPU 571 executes a control program for the post-processing apparatus to realize various functions. The RAM 572 stores a calculation result, a processing result, and the like of the CPU 571. The ROM 573 stores the above control program, various parameters, and the like.

Note that, in the present embodiment, the case in which the post-processing apparatus 500 has a configuration to perform side stitch processing has been described as an example. However, the post-processing apparatus 500 may have a post-processing configuration other than the side stitch processing, such as saddle stitch processing, folding processing, punching processing, or decurling processing.

<Stop Point>

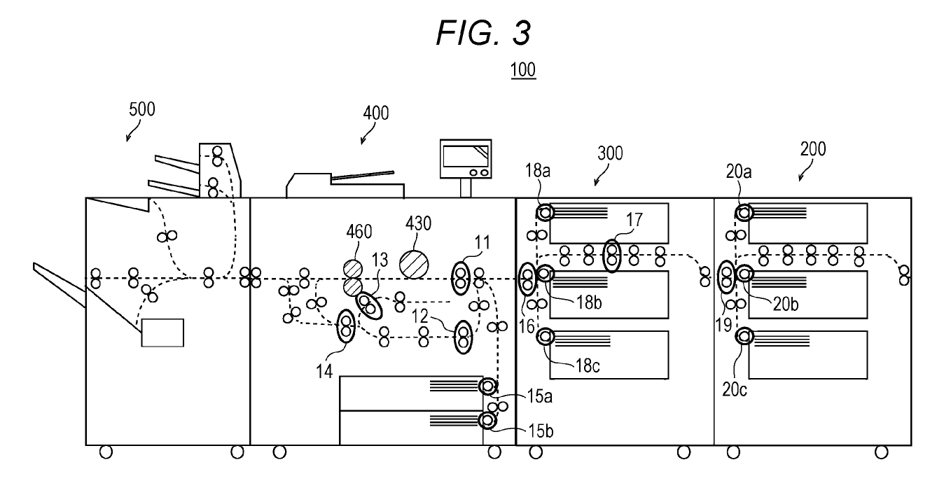

FIG. 3 is a diagram schematically illustrating stop points in the image forming system 100 illustrated in FIG. 1. In a state where a sheet is stopped, the vicinity of a leading end of the sheet is located at a stop point.

The controller 490 stops, in a case of performing automatic purge processing, respective residual sheets being conveyed on the conveyance paths in the apparatuses at predetermined stop points after detection of a jam in order to facilitate the automatic purge processing. In the automatic purge processing, reconveyance of the residual sheets starts from the stop points.

As illustrated in FIG. 3, in the case of the inside of the image forming apparatus 400, the stop points are preset to positions avoiding the image former 430, the fixer 460, a sharply curved conveyance path, and the like. The image forming system 100 includes, as an example, stop points 11 to 14, 15a, and 15b in the image forming apparatus 400, stop points 16, 17, and 18a to 18c in the second sheet feeding apparatus 300, and stop points 19, and 20a to 20c in the first sheet feeding apparatus 200. The stop point 11 is located at the resist roller pair 451 of the image forming apparatus 400, and the stop point 12 is located at the conveyance roller in the circulation conveyor 453. Further, the stop point 13 is located at the conveyance roller of the sheet inverter 452, and the stop point 14 is located at the conveyance roller at a branch point between the sheet inverter 452 and the circulation conveyor 453. Further, the stop points 15a and 15b are located at the conveyance rollers at outlets of the upper tray 441 and the lower tray 442 of the sheet feeder 440, respectively. Further, the stop point 16 is located at the conveyance roller at a discharge port of the second sheet feeding apparatus 300, the stop point 17 is located in the middle of the conveyance path of the horizontal conveyor 321, and the stop points 18a to 18c are located at outlets of the upper to lower trays 311 to 313, respectively. Further, the stop point 19 is located at the conveyance roller at a discharge port of the first sheet feeding apparatus 200, and the stop points 20a to 20c are located at outlets of the upper to lower trays 211 to 213, respectively.

The residual sheet is stopped by stop processing to be described below at the time when the leading end of the residual sheet reaches each stop point. As a result, the residual sheet is temporarily stopped in a state where the leading end of the residual sheet is located at each stop point.

Note that the above-described stop points 11 to 14, 15a, 15b, 16, 17, 18a to 18c, 19, and 20a to 20c of the image forming system 100 are merely examples, and the stop points are not limited the examples. Further, different positions and the number of stop points may be set for the stop points according to the sheet size to be used.

<Jam in ADU Frame 454>

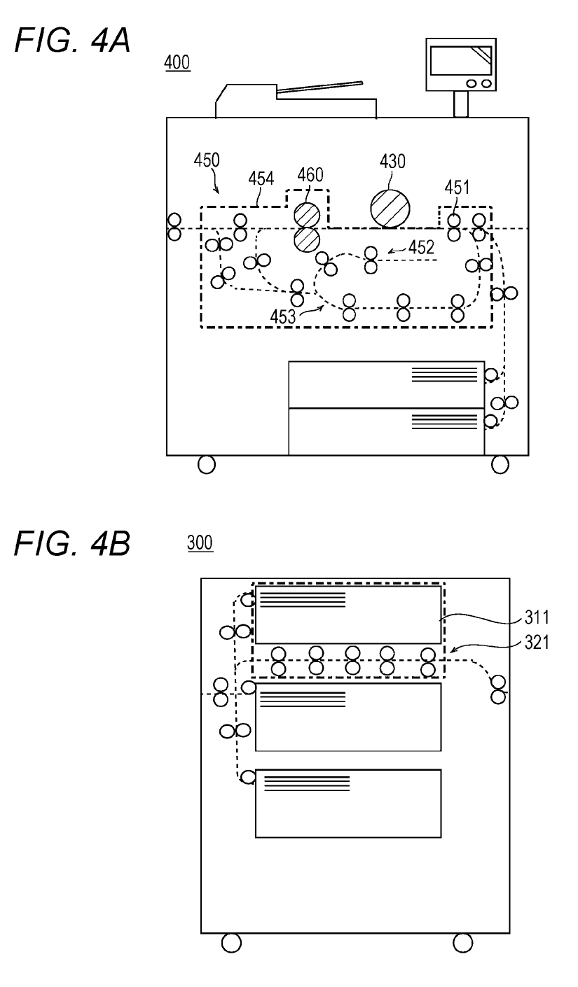

FIG. 4A is a diagram schematically illustrating an ADU frame 454 of the image forming apparatus 400 illustrated in FIG. 1. In FIG. 4A, a schematic outer shape of the ADU frame 454 is illustrated by a one-dot chain line. The ADU frame 454 incorporates the conveyance path of the sheet conveyor 450, the resist roller pair 451, the fixer 460, and the like, and supports them. The ADU frame 454 is drawably provided to the outside of the casing of the image forming apparatus 400 from the depth toward the front of the page.

In a case where a jam has occurred in the ADU frame 454 (for example, in a middle part or a lower part of the ADU frame 454 to be described below), the user pulls out the ADU frame 454 and removes the jammed sheet. However, in a case where a residual sheet is stopped over the conveyance path inside and outside the ADU frame 454, that is, in a case where the residual sheet is in a so-called “guillotine state”, the residual sheet becomes an obstacle when the jammed sheet is removed. If the ADU frame 454 is pulled out toward the front side that is an apparatus front direction (hereinafter simply referred to as “front side”) while the residual sheet remains over the conveyance path inside and outside the ADU frame 454, there is a possibility that the residual sheet is damaged. Therefore, in the case where the residual sheet is stopped over the conveyance path inside and outside the ADU frame 454, it is desirable to remove the jammed sheet after the residual sheet is moved to another position.

Meanwhile, in a case where the residual sheet is stopped at a predetermined stop point for automatic purge, the residual sheet needs to be re-conveyed from the predetermined stop point. Therefore, in a case where the residual sheet scheduled for automatic purge is stopped at a position where the residual sheet hinders removal of the jammed sheet by the user, the removal of the jammed sheet and the residual sheet can be said to be in a conflict relationship.

To handle the above situation, in the present embodiment, the residual sheet located at the position where the residual sheet hinders the removal of the jammed sheet is moved to another position before the removal of the jammed sheet, whereby the conflict relationship between the removal of the jammed sheet and the residual sheet is eliminated, and both the removal of the jammed sheet and the automatic purge of the residual sheet are achieved. As will be described below, the movement of the residual sheet to another position can be performed by any of methods: movement of the residual sheet to a downstream stop point; the automatic purge processing for the residual sheet before the removal of the jammed sheet; and removal of the residual sheet by the user.

The movement of the residual sheet to a downstream stop point is movement from a certain stop point to another downstream stop point and thus does not affect the automatic purge processing. Further, the automatic purge processing for the residual sheet before the removal of the jammed sheet is a method of performing the automatic purge processing for only the residual sheet that is an obstacle to the removal of the jammed sheet. As will be described below, in a case where another residual sheet is not stopped in the conveyance path to the purge tray 550, and the automatic purge processing for the residual sheet before the removal of the jammed sheet is not prohibited by user setting, the automatic purge processing is executable. Further, the removal of the residual sheet by the user is a method of removing the jammed sheet after removing the residual sheet that becomes an obstacle when the user removes the jammed sheet.

<Jam in Horizontal Conveyor 321 of Second Sheet Feeding Apparatus 300>

FIG. 4B is a diagram schematically illustrating the upper tray 311 and the horizontal conveyor 321 of the second sheet feeding apparatus 300 illustrated in FIG. 1.

In FIG. 4B, a range including the upper tray 311 and the horizontal conveyor 321 is schematically illustrated by a one-dot chain line. There is the conveyance path of the horizontal conveyor 321 below the upper tray 311, and the upper tray 311 is drawably provided to the outside of the casing of the second sheet feeding apparatus 300 from the depth toward the front of the page.

For example, in a case where a jam has occurred in the conveyance path of the horizontal conveyor 321, the user pulls out the upper tray 311 to the front side and removes the jammed sheet. The user can access the horizontal conveyor 321 by pulling out the upper tray 311. However, if the residual sheet is stopped at the outlet of the upper tray 311, the residual sheet becomes an obstacle when the jammed sheet is removed. In such a case, the conflict relationship between the removal of the jammed sheet and the residual sheet needs to be eliminated by moving the residual sheet located at the position where the residual sheet hinders the removal of the jammed sheet to another position before the removal of the jammed sheet.

As for the jam in the second sheet feeding apparatus 300, the conflict relationship between the removal of the jammed sheet and the residual sheet is eliminated by any of the methods: the movement of the residual sheet to a downstream stop point; the automatic purge processing for the residual sheet before the removal of the jammed sheet; and the removal of the residual sheet by the user.

Further, as for the jam in the first sheet feeding apparatus 200, the conflict relationship between the removal of the jammed sheet and the residual sheet is eliminated by any of the methods: the movement of the residual sheet to a downstream stop point; the automatic purge processing for the residual sheet before the removal of the jammed sheet; and the removal of the residual sheet by the user.

<Method of Controlling Image Forming System 100>

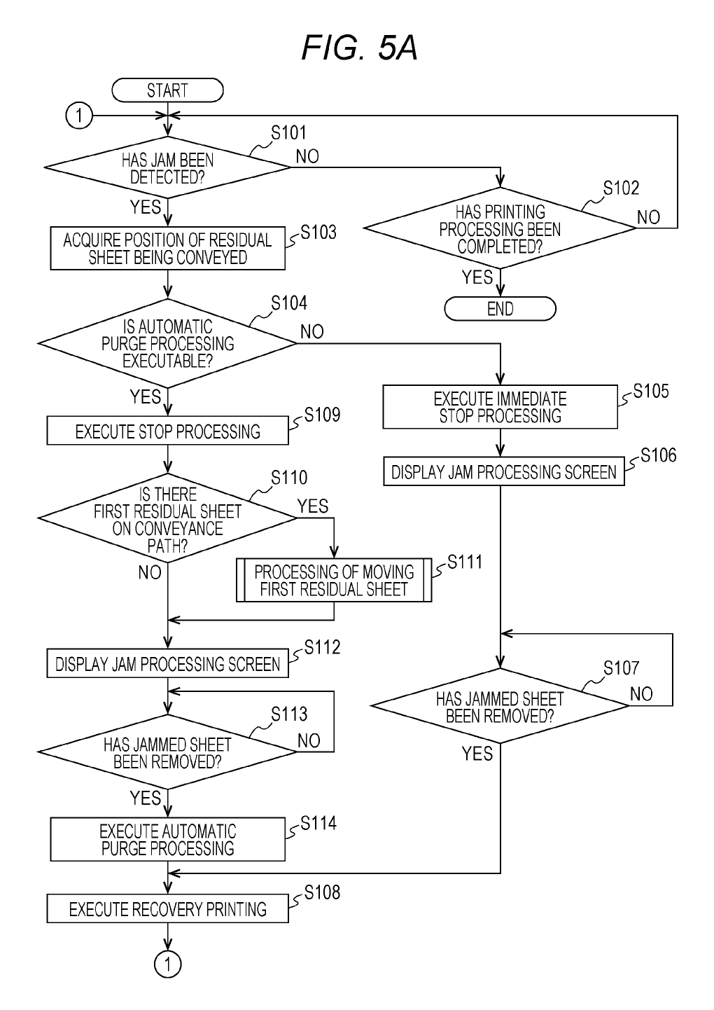

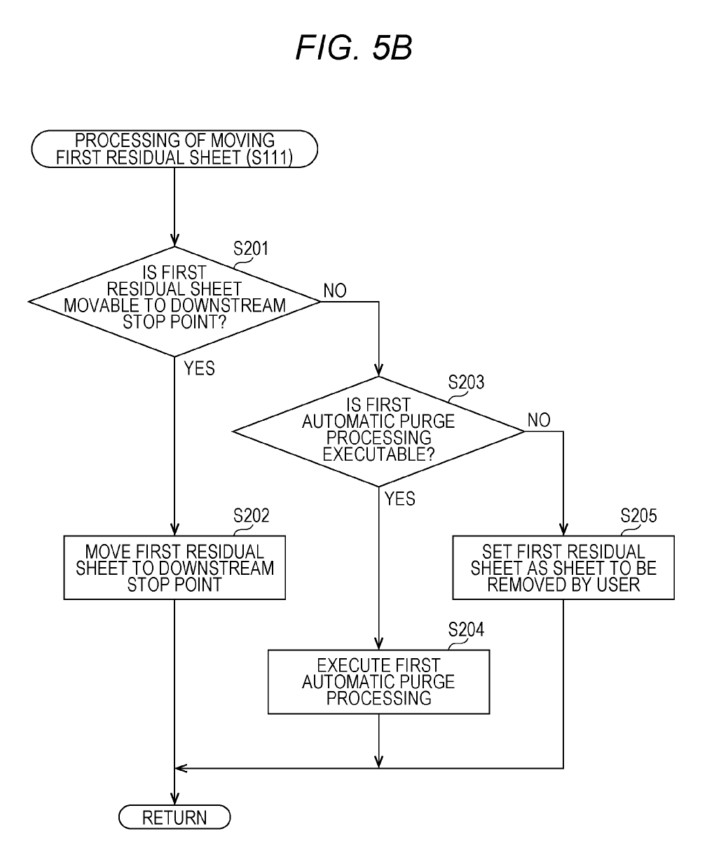

Next, a method of controlling the image forming system 100 of the present embodiment will be specifically described with reference to FIGS. 5A and 5B. FIG. 5A is a flowchart exemplarily illustrating a method of controlling the image forming system 100 according to the present embodiment, and FIG. 5B is a subroutine flowchart exemplarily illustrating processing of step S111 in FIG. 5A.

The processing of the flowcharts illustrated in FIGS. 5A and 5B is realized by the controller 240, the controller 340, the controller 490, and the controller 570 in cooperation with one another. Note that, in the following description, a case where the controller 490 plays a leading role for the controller 240, the controller 340, and the controller 570 will be described for convenience of description. However, the embodiment is not limited to the case.

The image forming system 100 according to the present embodiment determines whether to execute the automatic purge processing according to conditions such as the positions of the jammed sheet and residual sheet on the conveyance path and the sheet type of the residual sheet after detecting the jam on the conveyance path. Further, in the case of executing the automatic purge processing, the image forming system 100 determines whether to execute the automatic purge processing in a dispersed manner before and after removal of the jammed sheet by the user according to the above conditions. That is, the image forming system 100 can execute the automatic purge processing before removal of the jammed sheet by the user after detecting the jammed sheet and can execute the automatic purge processing again after removal of the jammed sheet. By performing first automatic purge processing, the residual sheet expected to become an obstacle when the user removes the jammed sheet can be discharged. Hereinafter, a specific processing procedure of the method of controlling the image forming system 100 according to the present embodiment will be described.

The image forming system 100 receives a print job from a client terminal or the like and starts printing processing. When the printing processing is started, the controller 490 acquires the positions of the sheets on the conveyance paths of the apparatuses of the image forming system 100 on the basis of the detection results of the plurality of sheet detection sensors in the conveyance paths of the apparatuses, and manages the sheet conveyance in an integrated manner.

Further, the jam detector constantly monitors jams on the conveyance paths by the sheet detection sensors. The jam information includes, for example, position information of the jammed sheet in the conveyance path, and is stored in the RAM 493 of the controller 490.

As illustrated in FIG. 5A, first, the controller 490 determines whether a jam has been detected, for example (step S101). The controller 490 determines whether a jam has been detected in the image forming system 100 on the basis of the jam information stored in the RAM 493.

When no jam has been detected (step S101: NO), the controller 490 determines whether the printing processing has been completed (step S102). The controller 490 determines whether the printing processing for the last received print job has been completed. When the printing processing has not been completed (step S102: NO), the processing returns to step S101. On the other hand, in a case where the printing processing has been completed (step S102: YES), the controller 490 terminates the control processing (end).

On the other hand, in a case where the jam has been detected (step S101: YES), the controller 490 acquires the positions of the residual sheets being conveyed (step S103). The controller 490 acquires the positions of the residual sheets being conveyed on the conveyance paths on the basis of the detection results of the sheet detection sensors in the conveyance paths in the apparatuses.

Next, the controller 490 determines whether the automatic purge processing is executable (step S104). The controller 490 determines that the automatic purge processing is executable in a case where the residual sheets being conveyed on the conveying paths can be stopped at predetermined stop points. The predetermined stop points are the positions 11 to 20c and the like illustrated in FIG. 3, for example. For example, in a case where the number of the residual sheets being conveyed is larger than the number of the stop points and there is a residual sheet that cannot be stopped at any of the stop points, the automatic purge processing is determined as not executable. Further, in a case where no residual sheets exist on the conveyance paths of any of the apparatuses of the image forming system 100, the automatic purge processing is determined as not executable.

In the case where the automatic purge processing is not executable (step S104: NO), the controller 490 executes immediate stop processing (step S105). The controller 490 stops the sheet conveyance of the apparatuses of the image forming system 100 to have a state where the user can remove the jammed sheet.

Specifically, the controller 490 stops rotation of all the conveyance rollers of the apparatuses. As a result, in the case where there are the residual sheets being conveyed in the apparatuses, all the residual sheets are stopped on the spot. Note that even if there is a sheet near a place where the sheet is deformed, such as the image former 430 or the fixer 460, the sheet is stopped on the spot.

Next, a jam processing screen is displayed (step S106). The controller 490 causes a display of an operation display 380 to display a message prompting the user to remove the jammed sheet. The user removes the jammed sheet according to the content displayed on the display. Further, in a case where there is the residual sheet in the conveyance path, the controller 490 causes the display of the operation display 380 to display a message prompting the user to remove the residual sheet. The user also removes the residual sheet according to the content displayed on the display.

Next, the controller 490 determines whether the jammed sheet has been removed (step S107). The controller 490 determines whether the residual sheet has also been removed. In a case where the jammed sheet has not been removed (step S107: NO), the controller 490 waits until the jammed sheet is removed. On the other hand, in a case where the jammed sheet has been removed (step S107: YES), the controller 490 performs recovery printing (step S108). The controller 490 controls the apparatuses to form images, which have been supposed to be formed on the removed jammed sheet and residual sheets, on newly supplied sheets. Then, the processing proceeds to step S101.

Meanwhile, in a case where the automatic purge processing is executable (step S104: YES), the controller 490 performs stop processing (step S109). The controller 490 plans an apparatus and a point of the apparatus at which each residual sheet being conveyed in the image forming system 100 is stopped according to a conveyance position, and stops the residual sheet at the stop point appropriate for the automatic purge processing. For example, each residual sheet being conveyed in the image forming system 100 is moved to stop at any of the predetermined stop points 11 to 20c illustrated in FIG. 3.

Further, the controller 490 determines whether there is a residual sheet on the conveyance path, the residual sheet for which the printing processing has been completed and being immediately dischargeable. In a case where there is such a residual sheet, the controller 490 conveys the residual sheet toward the downstream as the effective sheet and discharges the residual sheet to the main tray 540 of the post-processing apparatus 500.

Next, the controller 490 determines whether there is a first residual sheet on the conveyance path (step S110). The controller 490 determines whether there is the first residual sheet that satisfies a predetermined condition on the conveyance path after the stop processing. The predetermined condition is determined according to the position of the jammed sheet, a stopped position of the residual sheet, the sheet type, and the like. In the present embodiment, the first residual sheet is a residual sheet located at a position where the residual sheet hinders removal of the jammed sheet by the user, a tab sheet having a determined output order, or the like. Details of first residual sheet presence/absence determination will be described below.

In a case where there is the first residual sheet on the conveyance path (step S110: YES), the controller 490 performs moving processing for the first residual sheet (step S111). The moving processing for the first residual sheet will be described with reference to FIG. 5B.

The controller 490 determines whether the first residual sheet is movable to a downstream stop point (step S201). The downstream stop point is a stop point at which the automatic purge processing (third automatic purge processing) can be appropriately performed after removal of the jammed sheet without hindering removal of the jammed sheet by the user. Therefore, the downstream stop point to which the first residual sheet has been moved and which becomes an obstacle to the automatic purge processing is excluded. For example, in a case where a tailing end of the first residual sheet after movement stays over the fixer 460, the first residual sheet may become an obstacle to the automatic purge processing afterward due to bending (curling) of the sheet by heat during stop, and therefore the controller 490 determines that the movement to the downstream stop point is not possible.

In a case where the first residual sheet is movable to the downstream stop point (step S201: YES), the controller 490 controls the first residual sheet to be moved to the downstream stop point (a stop point at which the residual sheet is determined as not the first residual sheet (described below)) (step S202), and the processing proceeds to the processing of step S112 in FIG. 5A (return).

On the other hand, in a case where the first residual sheet is not movable to the downstream stop point (step S201: NO), the controller 490 determines whether the first automatic purge processing is executable (step S203). The controller 490 determines whether the automatic purge processing for the first residual sheet is executable. In a case where the automatic purge processing for the first residual sheet is executable (step S203: YES), the controller 490 executes the automatic purge processing for the first residual sheet (step S204) and the processing proceeds to the processing of step S112 in FIG. 5A (return). Details of the determination as to whether the first automatic purge processing is executable (step S203) will be described below.

On the other hand, in a case where the first automatic purge processing is not executable (step S203: NO), the controller 490 sets the first residual sheet as a sheet to be removed by the user (step S205) and the processing proceeds to the processing in step S112 in FIG. 5A (return).

Returning to FIG. 5A, in a case where there is no first residual sheet on the conveyance path (step S110: NO), the controller 490 displays the jam processing screen (step S112). The controller 490 causes a display of an operation display 380 to display a message prompting the user to remove the jammed sheet. Further, in a case where the first residual sheet is the sheet to be removed by the user, the controller 490 causes the display of the operation display 380 to display the message prompting removal of the first residual sheet.

Next, the controller 490 determines whether the jammed sheet has been removed (step S113). In the case where the first residual sheet is the sheet to be moved by the user, the controller 490 determines whether the first residual sheet has also been removed. In a case where the jammed sheet has not been removed (step S113: NO), the controller 490 waits until the jammed sheet is removed. On the other hand, in a case where the jammed sheet has been removed (step S113: YES), the controller 490 performs the automatic purge processing (step S114). The controller 490 performs the automatic purge processing after jammed sheet removal, for the residual sheets on the conveyance paths of the apparatuses.

Next, the controller 490 performs the recovery printing (step S108) and the processing proceeds to the processing of step S101.

In this manner, in the processing illustrated in the flowchart in FIG. 5A, the controller 490 determines whether the automatic purge processing is executable for the residual sheets on the conveyance paths of the apparatuses after detecting the jam, and executes the stop processing for the residual sheets in the case where the automatic purge processing is executable. Next, the controller 490 determines whether the first residual sheet that needs to be moved on the conveyance path before the jammed sheet is removed is included in a plurality of sheets stopped at the stop points by the stop processing. Then, the controller 490 executes the first automatic purge processing of automatically purging the first residual sheet before the jammed sheet is removed, and second automatic purge processing of automatically purging a second residual sheet different from the first residual sheet, of the sheets stopped at the stop points, after the jammed sheet is removed, according to a determination result.

[First Residual Sheet Presence/Absence Determination]

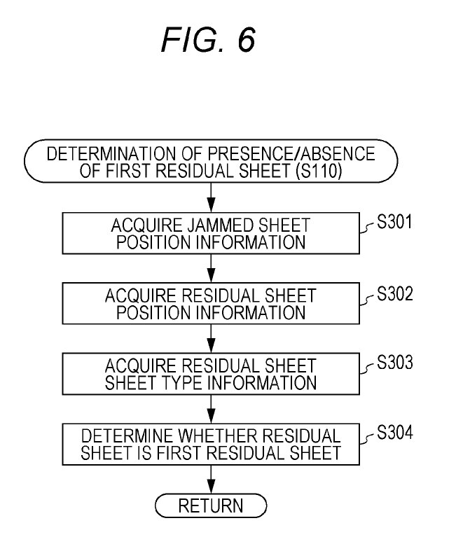

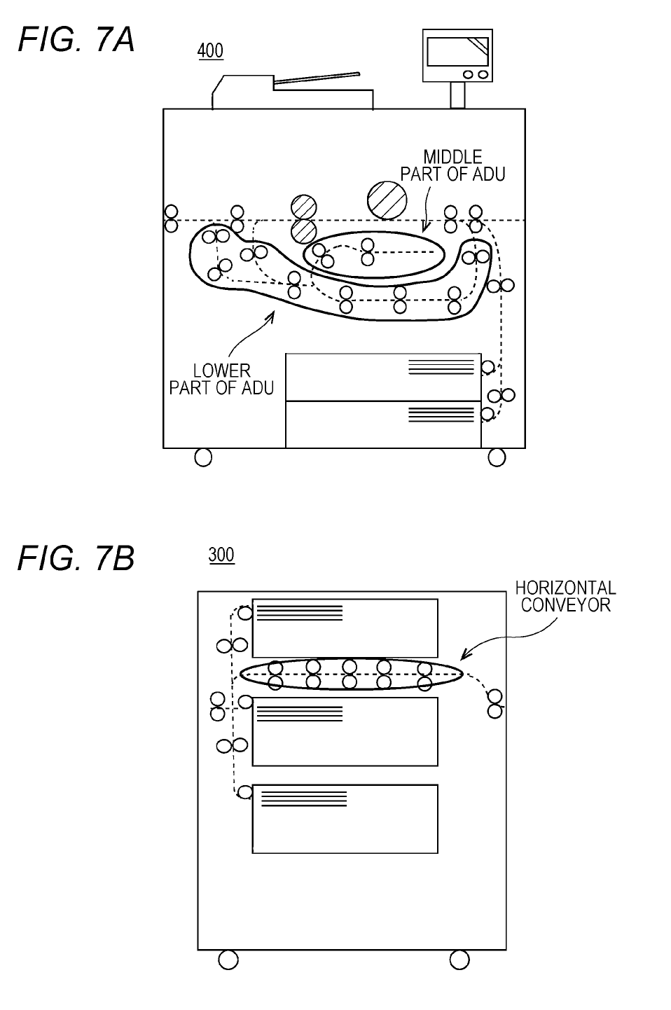

Next, the processing of first residual sheet presence/absence determination (step S110) in the flowchart in FIG. 5A will be described with reference to FIG. 6. FIG. 6 is a subroutine flowchart exemplarily illustrating the processing of step S110 in FIG. 5A. Further, FIGS. 7A and 7B are diagrams for describing a position of a jammed sheet in first residual sheet presence/absence determination.

As illustrated in FIG. 6, first, the controller 490 acquires the position information of the jammed sheet (step S301). The controller 490 acquires the position information of the jammed sheet from the jam information.

Next, the controller 490 acquires the position information of the residual sheet (step S302). The controller 490 acquires the position information of the residual sheets stopped at the stop points of the conveyance paths of the apparatuses by the processing of step S109.

Next, the controller 490 acquires sheet type information of the residual sheet (step S303). The controller 490 acquires the sheet type information of the residual sheets from the print setting information of the print job.

Next, the controller 490 determines whether the residual sheet is the first residual sheet (step S304). The controller 490 determines whether each of the residual sheets corresponds to the first residual sheet on the basis of the position of the jammed sheet in the image forming system 100, the stopped positions of the residual sheets, and the sheet type. In the present embodiment, the controller 490 determines that a sheet remaining on the conveyance path of each apparatus and stopped at a position corresponding to the position of the jammed sheet corresponds to the first residual sheet. Further, the controller 490 determines that a sheet having a predetermined order to be discharged to the main tray 540 and stopped at the outlet of the sheet feeder that has supplied the sheet, like a tab sheet, corresponds to the first residual sheet. Cases corresponding to the first residual sheet are illustrated in Table 1 below, for example.

No. 1 to No. 3 in the table are cases where the jammed sheet and the residual sheet conflict, that is, cases where the residual sheet hinders removal of the jammed sheet. No. 4 is a case where the residual sheet is a tab sheet.

No. 1 is a case where the jammed sheet is located in a lower part of the ADU and the residual sheet is at the resist roller (11), as illustrated in FIG. 7A. Further, No. 2 is a case where the jammed sheet is located in a middle part of the ADU, and the residual sheet is at the resist roller (11). No. 1 and No. 2 have no condition on the type of the residual sheet.

Further, No. 3 is a case where the jammed sheet is located at the horizontal conveyor 321 of the second sheet feeding apparatus 300 and the residual sheet is at the outlet (18a) of the upper tray 311, as illustrated in FIG. 7B. No. 3 has also no condition on the type of the residual sheet.

No. 4 has no condition on the position of the jammed sheet and is a case where the stopped position of the residual sheet is located at any of the outlets of the trays of the sheet feeder 440, the first sheet feeding apparatus 200, and the second sheet feeding apparatus 300 (15a/15b/18a/18b/18c/20a/20b/20c). Further, the sheet type of the residual sheet stopped at the outlet of the tray being a tab sheet is the condition. That is, No. 4 is a case where tab sheets are stored in the tray, and the residual sheet hinders reloading of the tab sheets accompanying ejection/insertion of the tray to align the order of the tab sheets.

TABLE 1

| | | | Sheet type of |
|---|---|---|---|
| Number | Position of jammed sheet | Stopped position of residual sheet | residual sheet |
| 1 | Lower part of ADU frame | Resist roller (11) | No condition |
| 2 | Middle part of ADU frame | Resist roller (11) | No condition |
| 3 | Horizontal conveyor of second | Outlet of upper tray of second | No condition |
| | sheet feeding apparatus | sheet feeding apparatus (18a) | |
| 4 | No condition | Any of outlets of trays | Sheet type = |
| | | (15a/15b/18a/18b/18c/20a/20b/20c) | Tab sheet |

[First Automatic Purge Processing Executability Determination]

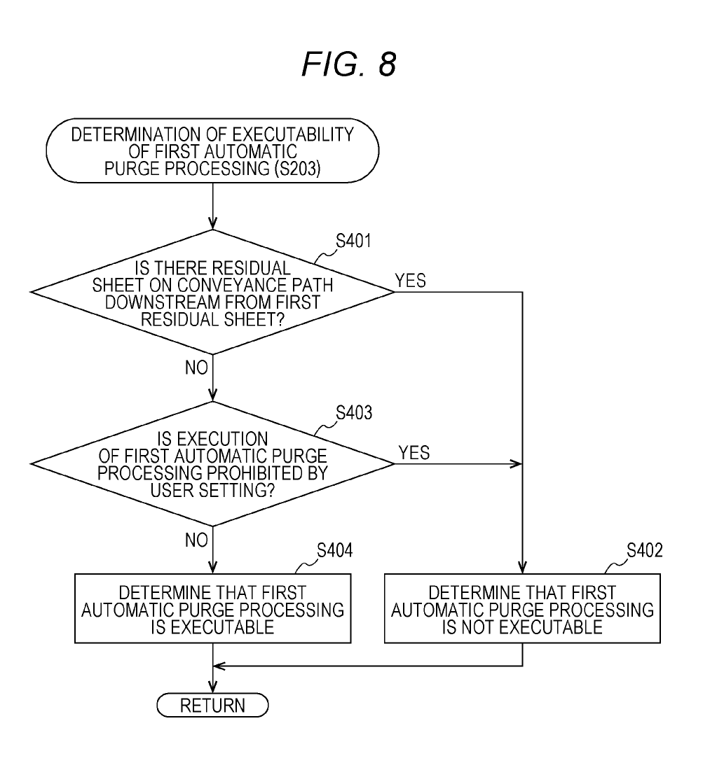

Next, determination as to whether the first automatic purge processing is executable (step S203) in the subroutine flowchart illustrated in FIG. 5B will be described with reference to FIG. 8. FIG. 8 is a subroutine flowchart exemplarily illustrating the processing of step S203 in FIG. 5B.

First, the controller 490 determines whether there is a residual sheet on the conveyance path downstream of the first residual sheet (step S401). The controller 490 determines whether the first residual sheet is conveyable to the purge tray 550, that is, whether there is a residual sheet on the conveyance path downstream of the first residual sheet. In a case where there is a residual sheet on the conveyance path downstream of the first residual sheet (step S401: YES), the controller 490 determines that the first automatic purge processing is not executable (step S402) and the processing proceeds to the processing of step S205 in FIG. 5B.

On the other hand, in a case where there is no residual sheet on the conveyance path downstream of the first residual sheet (step S401: NO), the controller 490 determines whether execution of the first automatic purge processing is prohibited by user setting (step S403). In the case where the execution of the first automatic purge processing is prohibited, the automatic purge processing is performed only once after jammed sheet processing. Therefore, there is an advantage that machine stop time is short as a whole. Also, since the processing procedure of the jam processing becomes the same as the processing procedure of ordinary jam processing accordingly, confusion of the user is less likely to occur. However, in the case where the residual sheet is in the guillotine state, the user needs to remove the residual sheet, which increases the number of operations of the user and is thus not desirable. Meanwhile, in a case of performing the first automatic purge processing, the processing procedure is different from that in the normal jam processing. However, there is an advantage that time and effort of removing the residual sheet by the user can be reduced. The user decides permission/prohibition of execution of the first automatic purge processing, taking these matters into consideration.

In a case where execution of the first automatic purge processing is prohibited by the user setting (step S403: YES), the controller 490 determines that the first automatic purge processing is not executable (step S402) and the processing proceeds to the processing of step S205 in FIG. 5B.

On the other hand, in a case where execution of the first automatic purge processing is not prohibited by the user setting (step S403: NO), the controller 490 determines that the first automatic purge processing is executable (step S404) and the processing proceeds to the processing of step S204 in FIG. 5B.

### EXAMPLES

Hereinafter, examples where the method of controlling the image forming system 100 of the present embodiment is applied will be described. In the following examples, for simplicity of description, cases where sheets supplied from the image forming apparatus 400 are discharged as they are without undergoing the post-processing by the post-processing apparatus 500 will be described.

### First Example

In a first example, a case of executing the automatic purge for the first residual sheet before removal of the jammed sheet (first automatic purge) and executing the automatic purge for the second residual sheet after removal of the jammed sheet (second automatic purge) will be described.

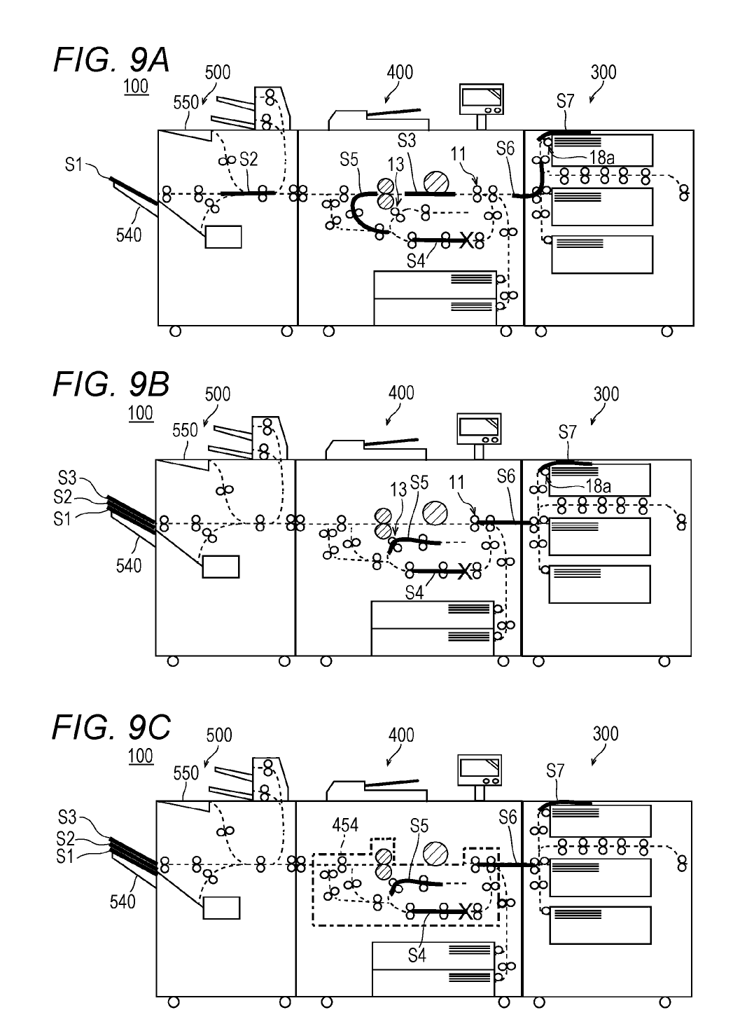

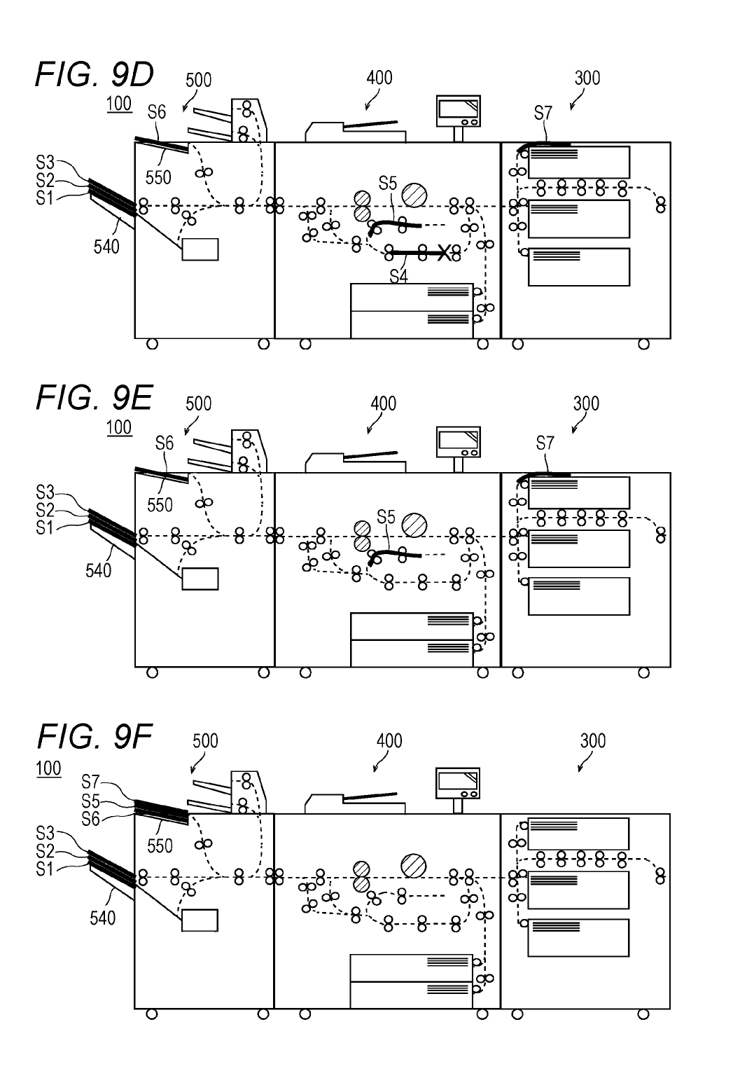

FIG. 9A is a schematic diagram exemplarily illustrating positions of sheets at the time of occurrence of a jam in the first example, and FIG. 9B is a schematic diagram exemplarily illustrating positions of sheets after the stop processing in the first example. Further, FIG. 9C is a schematic diagram exemplarily illustrating a case in which a residual sheet is stopped over the conveyance path inside and outside the ADU frame of the image forming apparatus in the first example, and FIG. 9D is a schematic diagram exemplarily illustrating positions of sheets after the first automatic purge processing is performed in the first example. Further, FIG. 9E is a schematic diagram exemplarily illustrating positions of sheets after a jammed sheet is removed in the first example, and FIG. 9F is a schematic diagram exemplarily illustrating positions of sheets after the second automatic purge processing is performed in the first example.

As illustrated in FIG. 9A, assuming a case in which A3-size sheets S1 to S7 are sequentially supplied from the second sheet feeding apparatus 300 to the image forming apparatus 400, and the sheet S4 has caused a jam while the double-sided printing is being performed. Since the first sheet feeding apparatus 200 is not used, illustration is omitted. In the drawings, the sheet S4 indicated by “x” is the jammed sheet.

The output order of the sheets specified by the print job is the order of sheets S1→S2→S3→S4→S5→S6→S7. Further, the printing order is the order of the front side of the sheet S1→the front side of S2→the front side of S3→the back side of S1→the front side of S4→the back side of S2→the front side of S5→the back side of S3→the front side of S6→the back side of S4→the front side of S7. In the example illustrated in FIG. 9A, a case in which the jam has occurred when printing on the back side of the sheet S3 has been completed.

The double-sided printing of the sheet S1 has already been completed and the sheet S1 is discharged to the main tray 540 as the effective sheet. Further, since the sheets S2 and S3 are on a downstream side of the jammed sheet S4 at the time when the jam has occurred and double-sided printing has already been completed, the controller 490 performs control to discharge the sheets S2 and S3 to the main tray 540 as the effective sheets.

Meanwhile, the controller 490 determines whether the sheets S5 to S7 being conveyed on the conveyance path on an upstream side of the jammed sheet S4 at the time when the jam has occurred can be stopped at predetermined stop points so that the automatic purge processing can be performed later. In the first example, it is assumed that the sheets S5 to S7 can be stopped at predetermined stop points, respectively, and thus the controller 490 determines that the automatic purge processing is executable.

The controller 490 executes the stop processing for the sheets S5 to S7 to perform the automatic purge processing. Since the sheet S5 is on an upstream side of the jammed sheet S4 at the time when the jam has occurred and printing on the front side has already been completed but printing on the back side has not been completed, the controller 490 performs control to convey the sheet S5 to the stop point 13 of the image forming apparatus 400. Further, since the sheet S6 is on an upstream side of the jammed sheet S4 at the time when the jam has occurred, and printing on the front side and the back side has not been completed, the controller 490 performs control to convey the sheet S6 to the stop point 11 (resist roller pair 451). Further, since the sheet S7 is on an upstream side of the jammed sheet at the time when the jam has occurred, and printing on the front side and the back side has not been completed, the controller 490 performs control to convey the sheet S7 to the stop point 18a of the second sheet feeding apparatus 300 (the outlet of the upper tray 311).

As illustrated in FIG. 9B, the sheets S2 and S3 are discharged as the effective sheets to the main tray 540 by the stop processing. Further, the sheet S5 is stopped at the stop point 13, the sheet S6 is stopped at the stop point 11, and the sheet S7 is stopped at the stop point 18a by the stop processing.

The sheets S5, S6, and S7 are scheduled to be discharged to the outside of the image forming system 100 by the automatic purge processing. However, since the jammed sheet S4 is located in the lower part of the ADU frame 454 and the sheet S6 is located at the stop point 11, the controller 490 determines that the sheet S6 corresponds to the first residual sheet according to Table 1.

As illustrated in FIG. 9C, to remove the jammed sheet S4, the ADU frame 454 (the part surrounded by the one-dot chain line) needs to be pulled out. However, the sheet S6 is stopped over the inside and outside of the ADU frame 454, that is, stopped over the inlet of the conveyance path of the image forming apparatus 400 and the outlet of the conveyance path of the second sheet feeding apparatus 300, and thus there is a possibility that the sheet S6 is damaged if the ADU frame 454 is pulled out. Therefore, in this state, the ADU frame 454 cannot be pulled out. To handle the situation, if the user manually (with a knob or the like (not illustrated)) moves the sheet S6 to a position where the sheet S6 does not become an obstacle to the pulling out of the ADU frame 454, the number of operations of the user increases and is not desirable.

Further, even in a case where the sheet S6 is short and is not located over the constituent elements inside and outside the ADU frame 454, that is, even in a case where the sheet S6 is not in the guillotine state, there is a possibility that the sheet S6 is viewed by the user when the user pulls out the ADU frame 454. If the sheet S6 is viewed by the user, the user may unexpectedly move the position of the sheet S6 or remove the sheet S6.

The user unexpectedly moving the sheet S6 may not only increase the number of operations of the user but also confuse the control of the automatic purge processing, and is thus not desirable. Therefore, the controller 490 executes the following processing for the sheet S6 as the first residual sheet.

The controller 490 determines whether the sheet S6 can be moved to the downstream stop point. In a case where the sheet S6 cannot be moved to the downstream stop point due to the length of the sheet S6 being long at the downstream stop point, for example, the controller 490 purges only the sheet S6 (first automatic purge) and discharges the sheet S6 to the purge tray 550 (see FIG. 9D). As a result, removal of the jammed sheet S4 becomes not disturbed by the sheet S6.

The controller 490 causes the display of the operation display 380 to display a message prompting the user to remove the jammed sheet S4. As illustrated in FIG. 9E, the user pulls out the ADU frame 454 and removes the jammed sheet S4.

As illustrated in FIG. 9F, the controller 490 performs the automatic purge processing (second automatic purge processing) for the sheets S5 and S7 other than the sheet S6. The sheets S5 and S7 are discharged to the purge tray 550. Thereafter, the controller 490 performs the recovery printing.

### Second Example

In a second example, a case of conveying the first residual sheet to the downstream stop point before removal of the jammed sheet and executing automatic purge for the first and second residual sheets after removal of the jammed sheet (third automatic purge) will be described.

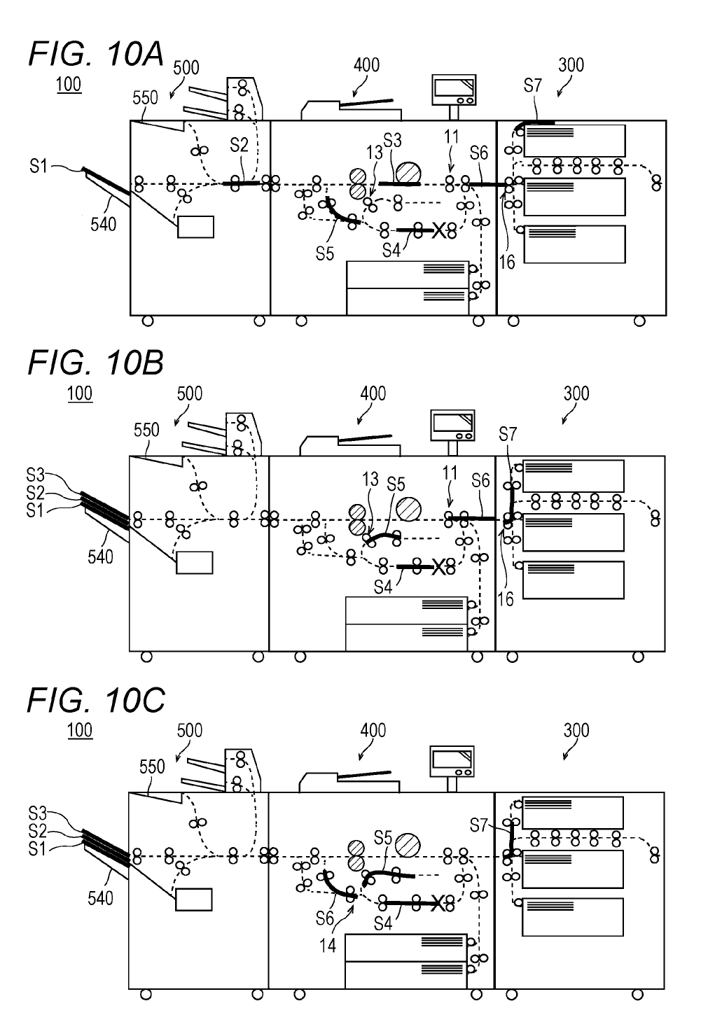

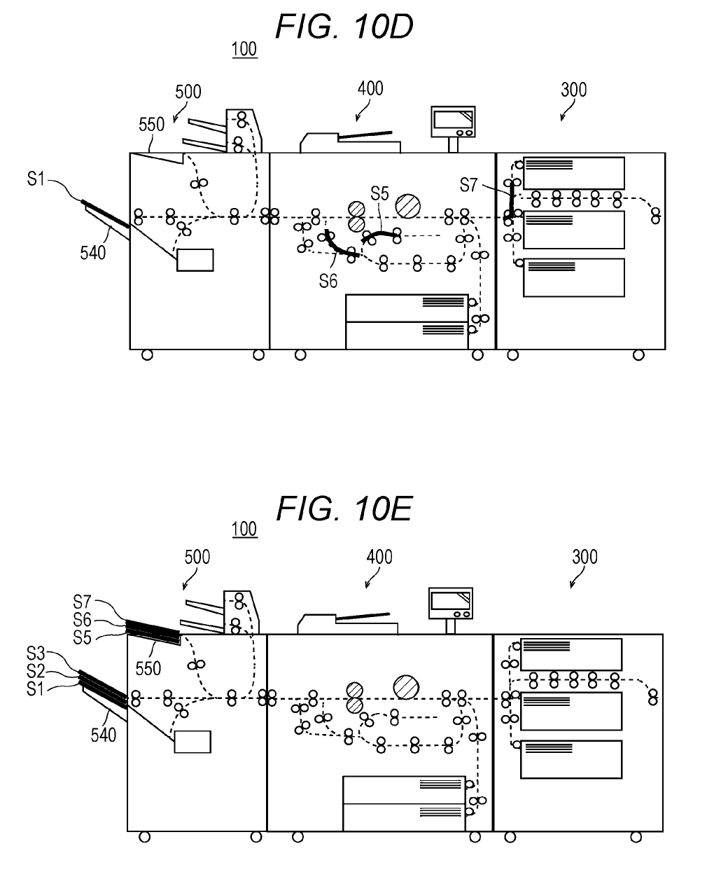

FIG. 10A is a schematic diagram exemplarily illustrating positions of sheets at the time of occurrence of a jam in the second example, and FIG. 10B is a schematic diagram exemplarily illustrating positions of sheets after the stop processing in the second example. Further, FIG. 10C is a schematic diagram exemplarily illustrating positions of sheets after a first residual sheet is moved to a downstream stop point in the second example, and FIG. 10D is a schematic diagram exemplarily illustrating positions of sheets after a jammed sheet is removed in the second example. Further, FIG. 10E is a schematic diagram exemplarily illustrating positions of sheets after the third automatic purge processing is performed in the second example.

As illustrated in FIG. 10A, assuming a case in which A4-size sheets S1 to S7 are sequentially supplied from the second sheet feeding apparatus 300 to the image forming apparatus 400, and the sheet S4 has caused a jam while the double-sided printing is being performed. The output order and the printing order of the sheets are the same as those in the first example.

The double-sided printing of the sheet S1 has already been completed and the sheet S1 is discharged to the main tray 540 as the effective sheet. Further, since the sheets S2 and S3 are on a downstream side of the jammed sheet S4 at the time when the jam has occurred and double-sided printing has already been completed, the controller 490 performs control to discharge the sheets S2 and S3 to the main tray 540 as the effective sheets.

Meanwhile, the controller 490 executes the stop processing for the sheets S5 to S7 to perform the automatic purge processing. Since the sheet S5 is on an upstream side of the jammed sheet S4 at the time when the jam has occurred and printing on the front side has already been completed but printing on the back side has not been completed, the controller 490 performs control to convey the sheet S5 to the stop point 13 of the image forming apparatus 400. Further, since the sheet S6 is on an upstream side of the jammed sheet S4 at the time when the jam has occurred, and printing on the front side and the back side has not been completed, the controller 490 performs control to convey the sheet S6 to the stop point 11 (resist roller pair 451). Further, since the sheet S7 is on an upstream side of the jammed sheet at the time when the jam has occurred, and printing on the front side and the back side has not been completed, the controller 490 performs control to convey the sheet S7 to the stop point 16 of the second sheet feeding apparatus 300 (the outlet of the second sheet feeding apparatus 300).

As illustrated in FIG. 10B, the sheets S2 and S3 are discharged as the effective sheets to the main tray 540 by the stop processing. Further, the sheet S5 is stopped at the stop point 13, the sheet S6 is stopped at the stop point 11, and the sheet S7 is stopped at the stop point 16 by the stop processing. The sheets S5, S6, and S7 are scheduled to be discharged to the outside of the image forming system 100 by the automatic purge.

As illustrated in FIG. 10C, since the controller 490 can move the sheet S6 to the downstream stop point 14, the controller 490 moves the sheet S6 to the stop point 14. As a result, removal of the jammed sheet S4 becomes not disturbed by the sheet S6.

The controller 490 causes the display of the operation display 380 to display a message prompting the user to remove the jammed sheet. As illustrated in FIG. 10D, the user pulls out the ADU frame 454 and removes the jammed sheet S4.

As illustrated in FIG. 10E, the controller 490 performs the automatic purge processing (third automatic purge processing) for the sheets S5, S6, and S7. The sheets S5, S6, and S7 are discharged to the purge tray 550. Thereafter, the controller 490 performs the recovery printing.

### Third Example

In a third example, a case of executing automatic purge for the second residual sheet after removal of the first residual sheet together with the jammed sheet (fourth automatic purge) will be described.

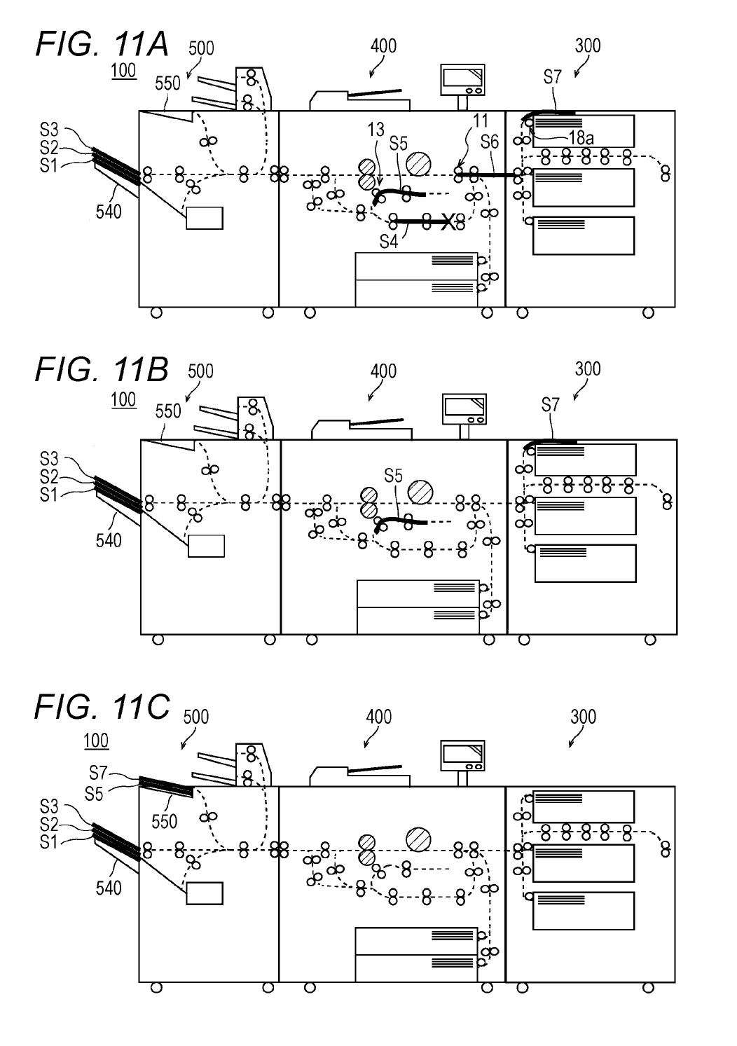

FIG. 11A is a schematic diagram exemplarily illustrating positions of sheets at the time of occurrence of a jam in the third example, and FIG. 11B is a schematic diagram exemplarily illustrating positions of sheets after a jammed sheet and a first residual sheet are removed in the third example. Further, FIG. 11C is a schematic diagram exemplarily illustrating positions of sheets after fourth automatic purge processing is performed in the third example.

Assuming a case in which A3-size sheets S1 to S7 are sequentially supplied from the second sheet feeding apparatus 300 to the image forming apparatus 400, and the sheet S4 has caused a jam while the double-sided printing is being performed, similarly to the above first example. The output order and the printing order of the sheets are the same as those in the first example. Further, the positions of the sheets S1 to S7 at the time when the jam has occurred are the same as the case of the first example (see FIG. 9A).

As illustrated in FIG. 11A, the sheets S2 and S3 are discharged as the effective sheets to the main tray 540 by the stop processing. Further, the sheet S5 is stopped at the stop point 13, the sheet S6 is stopped at the stop point 11, and the sheet S7 is stopped at the stop point 18a.

In the third example, a case in which the sheet S6 cannot be moved to the downstream stop point, and the first automatic purge processing cannot be performed for the sheet S6 is assumed. The controller 490 causes the display of the operation display 380 to display a message prompting the user to remove the jammed sheets S4 and S6.

As illustrated in FIG. 11B, the user pulls out the ADU frame 454 and removes the jammed sheet S4 and the sheet S6.

As illustrated in FIG. 11C, the controller 490 performs the automatic purge processing (fourth automatic purge processing) for the sheets S5 and S7 other than the sheet S6. The sheets S5 and S7 are discharged to the purge tray 550. Thereafter, the controller 490 performs the recovery printing.

### Fourth Example

In a fourth example, a case of having an insert sheet supplied, executing the automatic purge for the first residual sheet before the jam processing (first automatic purge), and executing the automatic purge for the second residual sheet after removal of the jammed sheet (second automatic purge) will be described.

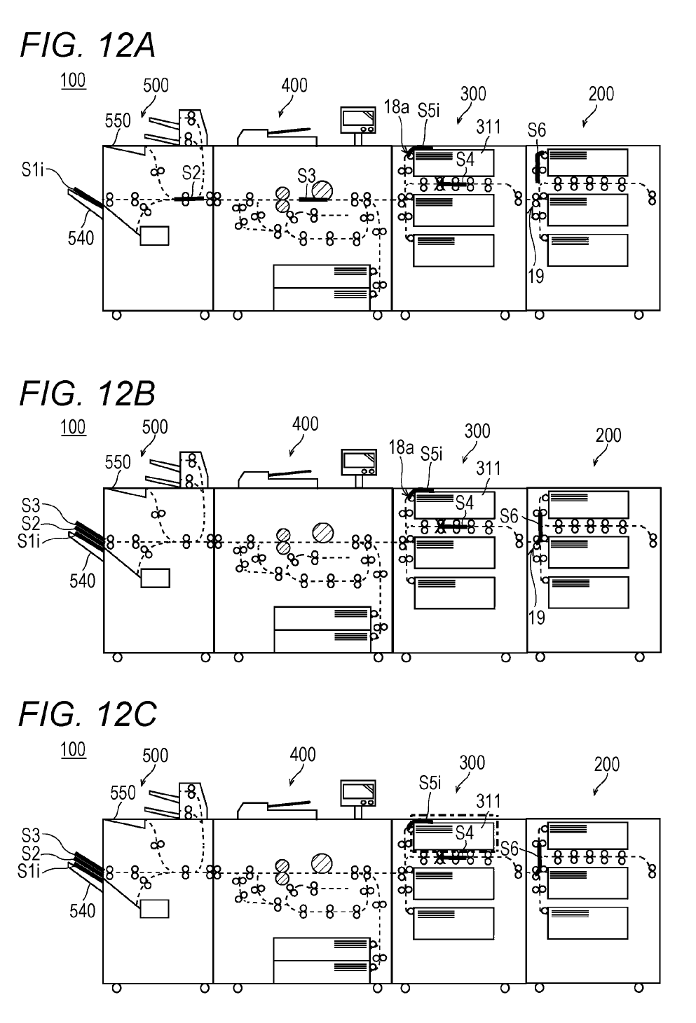

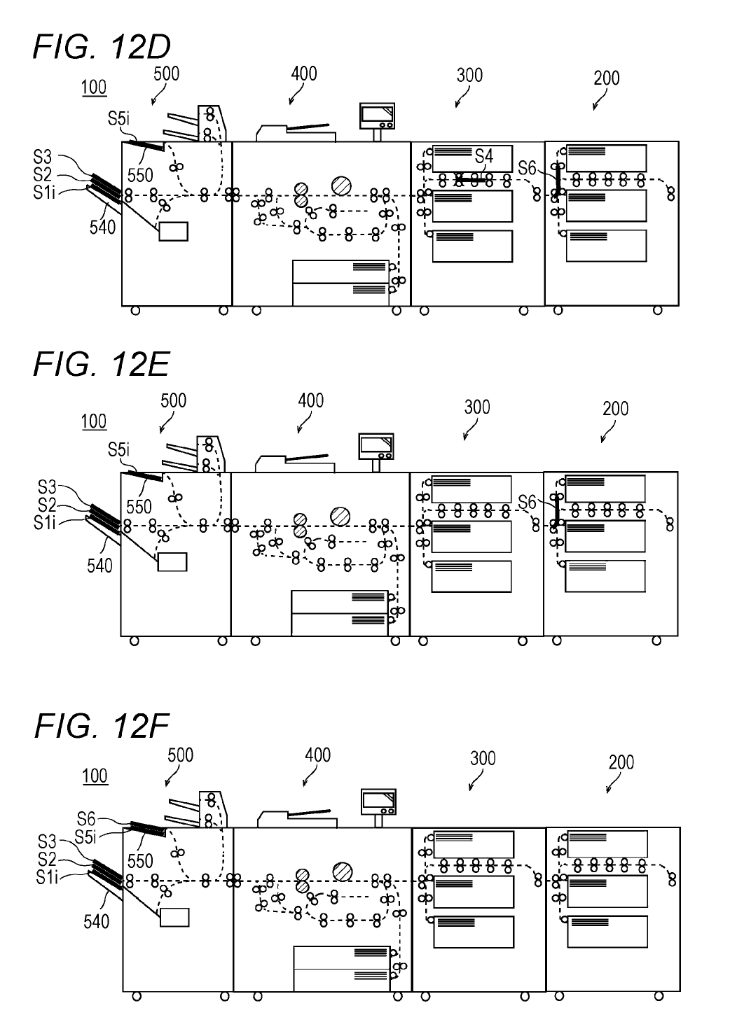

FIG. 12A is a schematic diagram exemplarily illustrating positions of sheets at the time of occurrence of a jam in the fourth example, and FIG. 12B is a schematic diagram exemplarily illustrating positions of sheets after the stop processing in the fourth example. Further, FIG. 12C is a schematic diagram exemplarily illustrating a case in which a residual sheet is stopped at the outlet of the upper tray of the second sheet feeding apparatus in the fourth example, and FIG. 12D is a schematic diagram exemplarily illustrating positions of sheets after the first automatic purge processing is performed in the fourth example. Further, FIG. 12E is a schematic diagram exemplarily illustrating positions of sheets after a jammed sheet is removed in the fourth example, and FIG. 12F is a schematic diagram exemplarily illustrating positions of sheets after the second automatic purge processing is performed in the fourth example.

As illustrated in FIG. 12A, assuming a case in which an A4-size sheet is supplied from the first sheet feeding apparatus 200 and an insert sheet is supplied from the second sheet feeding apparatus 300 to the image forming apparatus 400, and the sheet S4 has caused a jam while the single-sided printing is being performed in an insert mode. In the insert mode, one front cover+three-sheet book is printed. The output order and the printing order of the sheets specified by the print job are in the order of S1i (insert sheet)→S2→S3→S4→S5i (insert sheet)→S6. Note that “i” in S1i and S5i means insert sheet.

The printing of the sheet S1i has already been completed and the sheet S1i is discharged to the main tray 540 as the effective sheet. Further, since the sheets S2 and S3 are on a downstream side of the jammed sheet S4 at the time when the jam has occurred and printing has already been completed, the controller 490 performs control to discharge the sheets S2 and S3 to the main tray 540 as the effective sheets.

Meanwhile, the controller 490 determines whether the insert sheet S5i and the sheet S6 being conveyed on the conveyance path on an upstream side of the jammed sheet S4 at the time when the jam has occurred can be stopped at predetermined stop points so that the automatic purge processing can be performed later. In the fourth example, it is assumed that the insert sheet S5i and the sheet S6 can be stopped at predetermined stop points, respectively, and thus the controller 490 determines that the automatic purge processing is executable.

The controller 490 performs the stop processing for the insert sheets S5i, S6, and S7 to perform the automatic purge processing. The printing of the insert sheet S5i has not been completed. Therefore, the controller 490 performs control to convey the insert sheet S5i to the stop point 18a (the outlet of the upper tray 311).

The sheet S6 is on an upstream side of the jammed sheet S4 at the time when the jam has occurred, and printing has not been completed. Therefore, the controller 490 performs control to convey the sheet S6 to the stop point 19 (the outlet of the first sheet feeding apparatus 200).

As illustrated in FIG. 12B, the sheets S2 and S3 are discharged as the effective sheets to the main tray 540 by the stop processing. Further, the insert sheet S5i is stopped at the stop point 18a, and the sheet S6 is stopped at the stop point 19.

The insert sheet S5i and the sheet S6 are scheduled to be discharged to the outside of the image forming system 100 by the automatic purge processing. However, the jammed sheet S4 is located on the conveyance path of the horizontal conveyor 321 of the second sheet feeding apparatus 300 and the insert sheet S5i is located at the stop point 18a, the controller 490 determines that the insert sheet S5i corresponds to the first residual sheet according to Table 1.

As illustrated in FIG. 12C, to remove the jammed sheet S4, the upper tray 311 (the part surrounded by the one-dot chain line) needs to be pulled out. However, the insert sheet S5i is located over the upper tray 311 and the conveyance path at the outlet of the upper tray 311, and the insert sheet S5i may be damaged if the upper tray 311 is pulled out. Therefore, in this state, the upper tray 311 cannot be pulled out.

Therefore, the controller 490 determines whether the insert sheet S5i can be moved to the downstream stop point. As illustrated in FIG. 12D, in a case where the insert sheet S5i cannot be moved to the downstream stop point due to the insert sheet S5i being long for the downstream stop point or the like, the controller 490 performs the automatic purge processing (first automatic purge processing) for the insert sheet S5i only. By the processing, the controller 490 discharges the insert sheet S5i to the purge tray 550. As a result, removal of the jammed sheet S4 becomes not disturbed by the insert sheet S5i. The controller 490 causes the display of the operation display 380 to display a message prompting the user to remove the jammed sheet S4.

As illustrated in FIG. 12E, the user pulls out the upper tray 311 and removes the jammed sheet S4.

As illustrated in FIG. 12F, the controller 490 performs the automatic purge processing (second automatic purge processing) for the sheet S6 other than the insert sheet S5i. The sheet S6 is discharged to the purge tray 550. Thereafter, the controller 490 performs the recovery printing.

### Fifth Example

In a fifth example, a case of having an insert sheet supplied, and conveying the first residual sheet to the downstream stop point before removal of the jammed sheet and executing automatic purge for the first and second residual sheets after removal of the jammed sheet (third automatic purge) will be described.

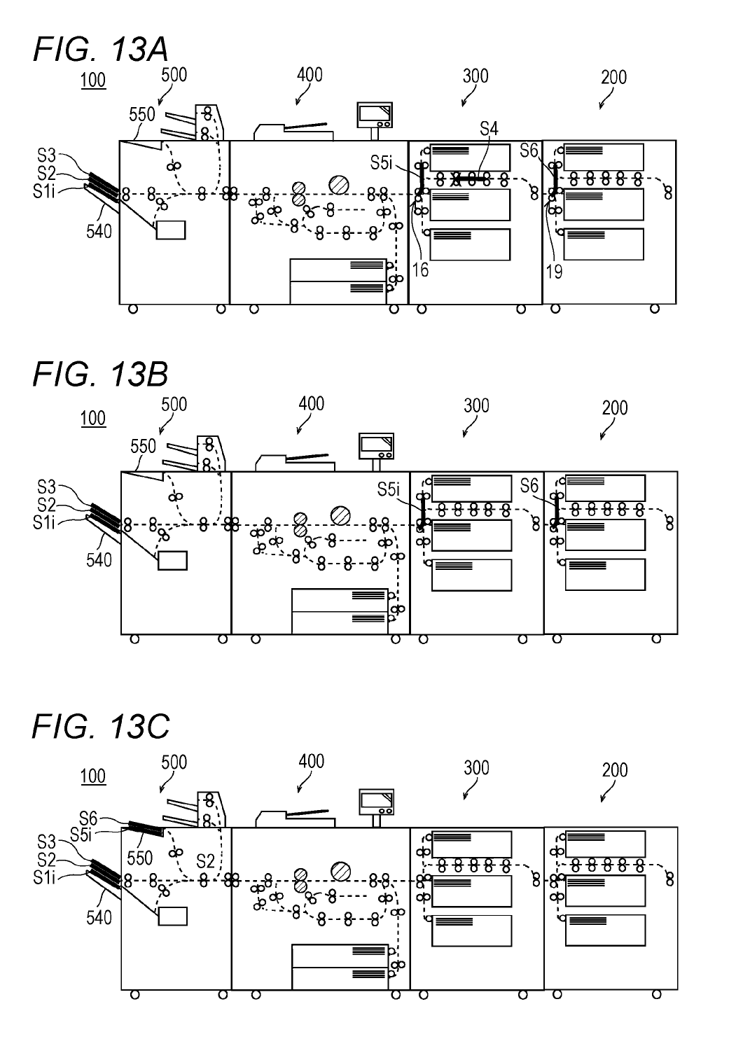

FIG. 13A is a schematic diagram exemplarily illustrating positions of sheets after a first residual sheet is moved to a downstream stop point in the fifth example, and FIG. 13B is a schematic diagram exemplarily illustrating positions of sheets after a jammed sheet is removed in the fifth example. Further, FIG. 13C is a schematic diagram exemplarily illustrating positions of sheets after the third automatic purge processing is performed in the fifth example.

Assuming a case in which an A4-size sheet is supplied from the first sheet feeding apparatus 200 and an insert sheet is supplied from the second sheet feeding apparatus 300 to the image forming apparatus 400, and the sheet S4 has caused a jam while the single-sided printing is being performed in the insert mode, similarly to the case of the fourth example. The output order and the printing order of the sheets are the same as those in the fourth example. Further, the positions of the sheets S1i to S6 at the time when the jam has occurred are also the same as the case of the fourth example (see FIG. 12A).

As illustrated in FIG. 13A, the sheets S2 and S3 are discharged as the effective sheets to the main tray 540 by the stop processing. Since the insert sheet S5i can be moved to the downstream stop point, the controller 490 moves the insert sheet S5i to the downstream stop point 16. The controller 490 causes the display of the operation display 380 to display a message prompting the user to remove the jammed sheet S4.

As illustrated in FIG. 13B, the user pulls out the upper tray 311 and removes the jammed sheet S4.

As illustrated in FIG. 13C, the controller 490 performs the automatic purge processing (third automatic purge processing) for the insert sheets S5i and S6. The insert sheets S5i and S6 are discharged to the purge tray 550. Thereafter, the controller 490 performs the recovery printing.

### Sixth Example

In a sixth example, a case of having a tab sheet supplied, executing the automatic purge for the first residual sheet before the jam processing (first automatic purge), and executing the automatic purge for the second residual sheet after removal of the jammed sheet (second automatic purge) will be described.

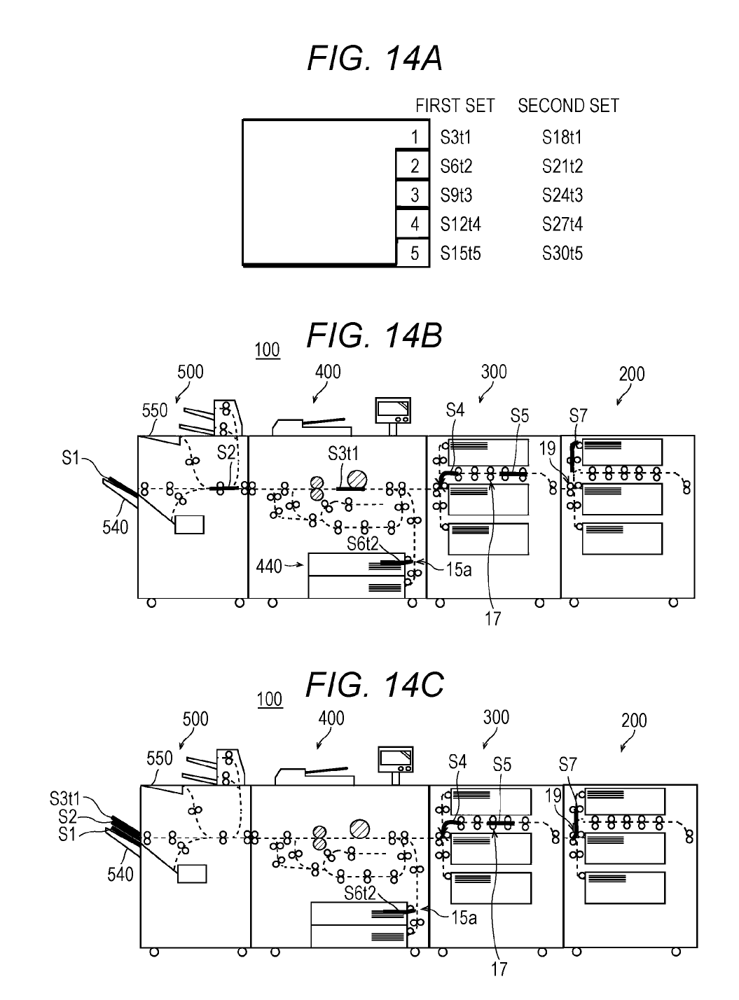

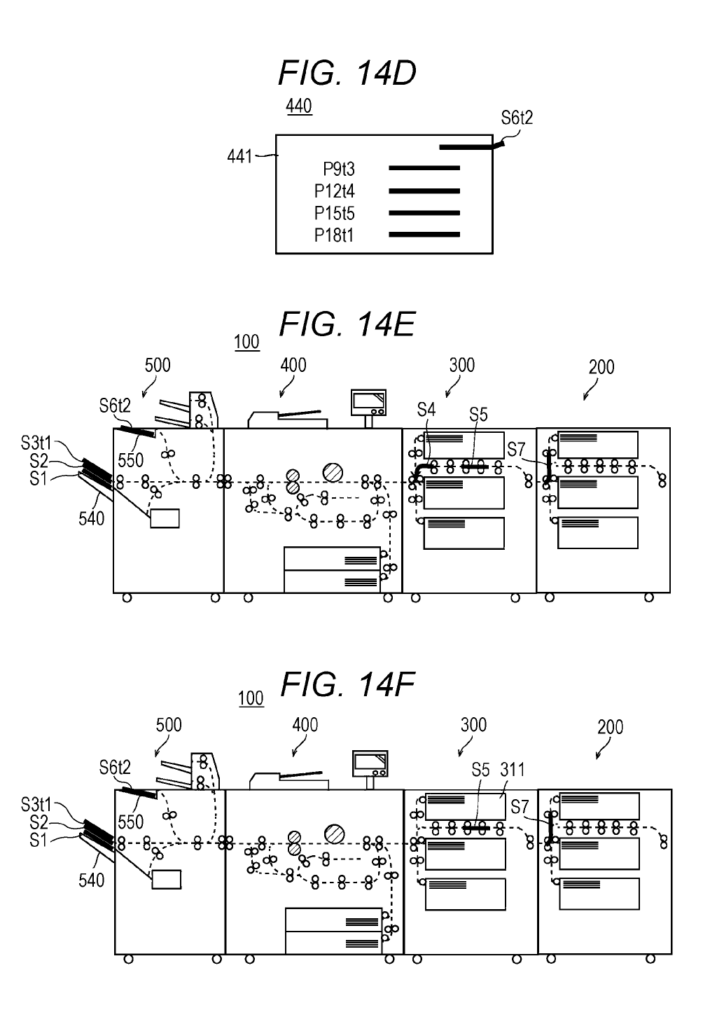

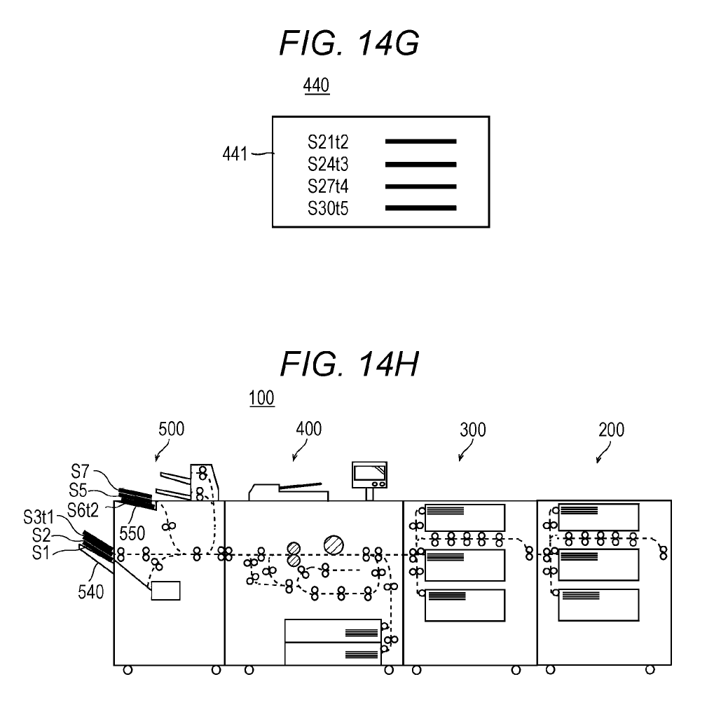

FIG. 14A is a schematic diagram exemplarily illustrating an arrangement order of tab sheets in the sixth example, and FIG. 14B is a schematic diagram exemplarily illustrating positions of sheets at the time of occurrence of a jam in the sixth example. Further, FIG. 14C is a schematic diagram exemplarily illustrating positions of sheets after the stop processing in the sixth example, and FIG. 14D is a schematic diagram exemplarily illustrating a sheet feeding order of tab sheets stored in the upper tray of the image forming apparatus in the sixth example. Further, FIG. 14E is a schematic diagram exemplarily illustrating positions of sheets after the first automatic purge processing is performed in the sixth example, and FIG. 14F is a schematic diagram exemplarily illustrating positions of sheets after a jammed sheet is removed in the sixth example. Further, FIG. 14G is a schematic diagram exemplarily illustrating a tab sheet reset in the upper tray of the image forming apparatus in the sixth example, and FIG. 14H is a schematic diagram exemplarily illustrating positions of sheets after the second automatic purge processing is performed in the sixth example.

In the sixth example, as illustrated in FIG. 14A, a case of printing the tab sheets in a tab sheet insertion mode, using a plurality of (two, for example) sets of tab sheets, a set being composed of five sheets, will be described. A set of tab sheets has tabs (indexes) 1 to 5 at positions not overlapping with one another when viewed from a stacking direction. In an initial state before the start of the printing processing, the tab sheets are stacked in the order of S3t1, S6t2, S9t3, . . . , S18t1, . . . , and S30t5 from the top in the upper tray 441 of the sheet feeder 440. A set of tab sheets needs to be discharged in predetermined order (for example, S3t1, S6t2, S9t3, . . . , and S15t5). In this way, the tab sheets have ordering for discharge. The numbers after “t” indicating tab sheet in S3t1, S6t2, and the like represent serial numbers of the tab sheets.

As illustrated in FIG. 14B, assuming a case in which tab sheets are supplied from the sheet feeder 440 and A4-size sheets are supplied from the first sheet feeding apparatus 200 and the second sheet feeding apparatus 300 to the image forming apparatus 400, and the sheet S4 has caused a jam while the single-sided printing is being performed in a tab sheet insertion mode. The output order and the printing order of the sheet specified by the print job are the order of sheets S1→S2→S3t1 (first tab sheet)→S4→S5 S6t2 (second tab sheet)→S7→ . . . .

The printing of the sheet S1 has already been completed and the sheet S1 is discharged to the main tray 540 as the effective sheet. Further, since the sheets S2 and S3t1 are on a downstream side of the jammed sheet S4 at the time when the jam has occurred and printing has already been completed, the controller 490 performs control to discharge the sheets S2 and S3t1 to the main tray 540 as the effective sheets.

Meanwhile, the controller 490 determines whether the sheets S5 to S7 being conveyed on the conveyance path on an upstream side of the jammed sheet S4 at the time when the jam has occurred can be stopped at predetermined stop points so that the automatic purge processing can be performed later. In the sixth example, it is assumed that the sheets S5 to S7 can be stopped at predetermined stop points, respectively, and thus the controller 490 determines that the automatic purge processing is executable.

The controller 490 executes the stop processing for the sheets S5, S6t2, and S7 to perform the automatic purge processing. Since the sheet S5 is on an upstream side of the jammed sheet S4 at the time when the jam has occurred, and printing has not been completed, the controller 490 performs control to convey the sheet S5 to the stop point 17. Further, since printing of the tab sheet S6t2 has not been completed at the time when the jam has occurred, the controller 490 performs control to convey the tab sheet S6t2 to the stop point 15a (the outlet of the upper tray 441). Further, since the sheet S7 is on an upstream side of the jammed sheet S4 at the time when the jam has occurred, and printing has not been completed, the controller 490 performs control to convey the sheet S7 to the stop point 19.

As illustrated in FIG. 14C, the sheets S2 and S3t1 are discharged as the effective sheets to the main tray 540 by the stop processing. Further, the sheet S5 is stopped at the stop point 17, the tab sheet S6t2 is stopped at the stop point 15a, and the sheet S7 is stopped at the stop point 19. The sheets S5, S6t2, and S7 are scheduled to be discharged to the outside of the image forming system 100 by the automatic purge processing.

As illustrated in FIG. 14D, the tab sheets are set on the upper tray 441 of the sheet feeder 440 in the order of S9t3→S12t4→S1515→S18t1 . . . from the top, and the tab sheets are sent out from the upper tray 441 to the conveyance path after the tab sheet S6t2.

However, in a case where the sheets S5, S6t2, and S7 are automatically purged after the jammed sheet S4 is removed, there is the tab sheet S9t3 on the top of the upper tray 441. Therefore, the controller 490 cannot resume the printing in the recovery printing in the order of the sheets S4→S5→S6t2→ . . . specified in the original print job.

To handle the situation, prompting the user to reset the tab sheets on the upper tray 441 when the jammed sheet S4 is removed is conceivable. However, since the tab sheet S6t2 is placed over the upper tray 441 and the outlet of the upper tray 441, the upper tray 441 cannot be pulled out.

Therefore, as illustrated in FIG. 14E, the controller 490 discharges the tab sheet S6t2 to the purge tray 550 by performing the automatic purge processing (first automatic purge processing) only for the tab sheet S6t2. As a result, pulling out of the upper tray 441 becomes not disturbed by the tab sheet S6t2. The controller 490 causes the display of the operation display 380 to display a message prompting the user to remove the jammed sheet S4.

As illustrated in FIG. 14F, the user pulls out the upper tray 311 of the second sheet feeding apparatus 300 and removes the jammed sheet S4. The controller 490 prompts the user to reset the tab sheets on the upper tray 441.

As illustrated in FIG. 14G, the user further resets the tab sheets on the upper tray 441 of the image forming apparatus 400. As a result, the tab sheet S21t2 is set on the top of the upper tray 441. Therefore, since the second tab sheet is supplied from the upper tray 441 to the image former 430, the correct output order is obtained at the recovery printing.

As illustrated in FIG. 14H, the automatic purge processing (second automatic purge processing) is performed for the sheets S5 and S7 other than the tab sheet S6t2. The sheets S5 and S7 are discharged to the purge tray 550. Thereafter, the controller 490 performs the recovery printing.

### Seventh Example

In a seventh example, a case of having a tab sheet supplied, and conveying the first residual sheet to the downstream stop point before removal of the jammed sheet and executing automatic purge for the first and second residual sheets after removal of the jammed sheet (third automatic purge) will be described.

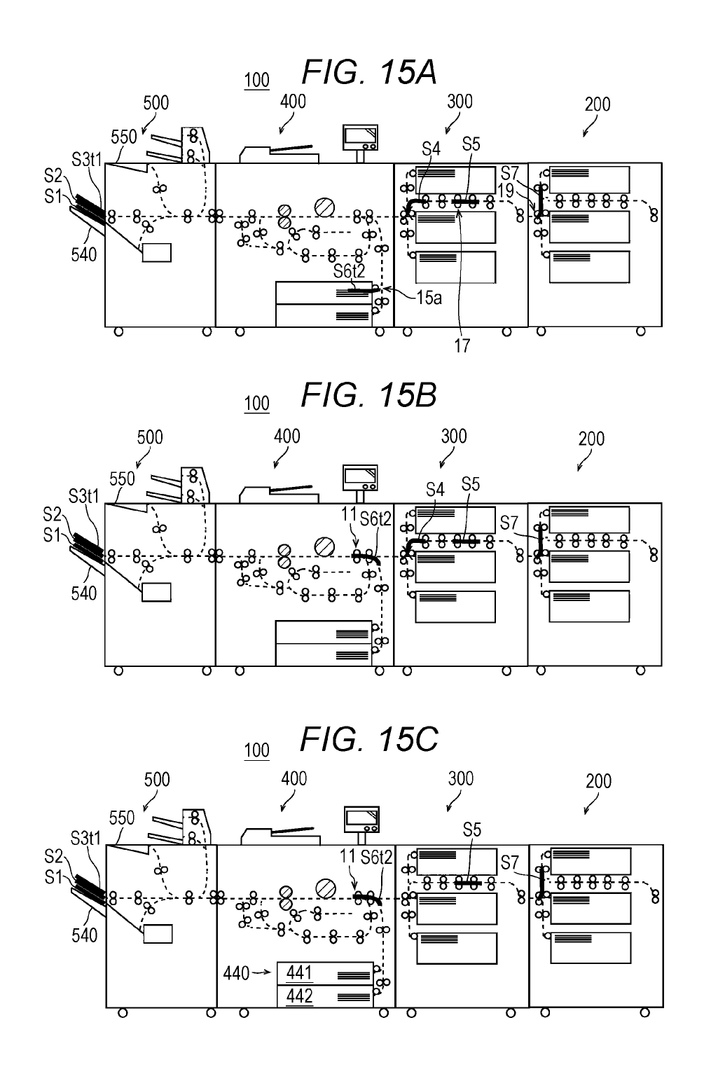

FIG. 15A is a schematic diagram exemplarily illustrating positions of sheets after the stop processing in the seventh example, and FIG. 15B is a schematic diagram exemplarily illustrating positions of sheets after a first residual sheet is moved to a downstream stop point in the seventh example. Further, FIG. 15C is a schematic diagram exemplarily illustrating positions of sheets after the third automatic purge processing is performed in the seventh example.

Assuming a case in which tab sheets are supplied from the sheet feeder 440 and A4-size sheets are supplied from the first sheet feeding apparatus 200 and the second sheet feeding apparatus 300 to the image forming apparatus 400, and the sheet S4 has caused a jam while the single-sided printing is being performed in a tab sheet insertion mode, similarly to the sixth example. The output order and the printing order of the sheet specified by the print job are the same as in the sixth example. Further, the positions of the sheets S1 to S7 at the time when the jam has occurred are the same as the case of the sixth example.

As illustrated in FIG. 15A, the sheet S2 and the tab sheet S3t1 are discharged as the effective sheets to the main tray 540 by the stop processing. Further, the sheet S5 is stopped at the stop point 17 of the second sheet feeding apparatus 300, the tab sheet S6t2 is stopped at the stop point 15a of the image forming apparatus 400, and the sheet S7 is stopped at the stop point 19 of the first sheet feeding apparatus 200.

As illustrated in FIG. 15B, since the controller 490 can move the tab sheet S6t2 to the downstream stop point 11, the controller 490 moves the tab sheet S6t2 to the stop point 11. As a result, removal of the jammed sheet S4 becomes not disturbed by the tab sheet S6t2. The controller 490 causes the display of the operation display 380 to display a message prompting the user to remove the jammed sheet S4 and reset the second tab sheet.

As illustrated in FIG. 15C, the user pulls out the upper tray 311 of the second sheet feeding apparatus 300 and removes the jammed sheet S4. The user further resets the tab sheets on the upper tray 441 of the sheet feeder 440. As a result, the second tab sheet (tab sheet S21t2) is set on the top of the upper tray 441. Since the user can reset the tab sheets at the same timing as removing the jammed sheet S4, it is not necessary to remove the jammed sheet S4 and reset the tab sheets at different timings and the burden on the user is reduced.

Next, the automatic purge processing (third automatic purge processing) is performed for the sheets S5, S6t2, and S7. The sheets S5, S6t2, and S7 are discharged to the purge tray 550. Thereafter, the controller 490 performs the recovery printing.

### Eighth Example

In an eighth example, a case of having a tab sheet supplied, and executing automatic purge for the second residual sheet after removal of the first residual sheet together with the jammed sheet (fourth automatic purge) will be described.

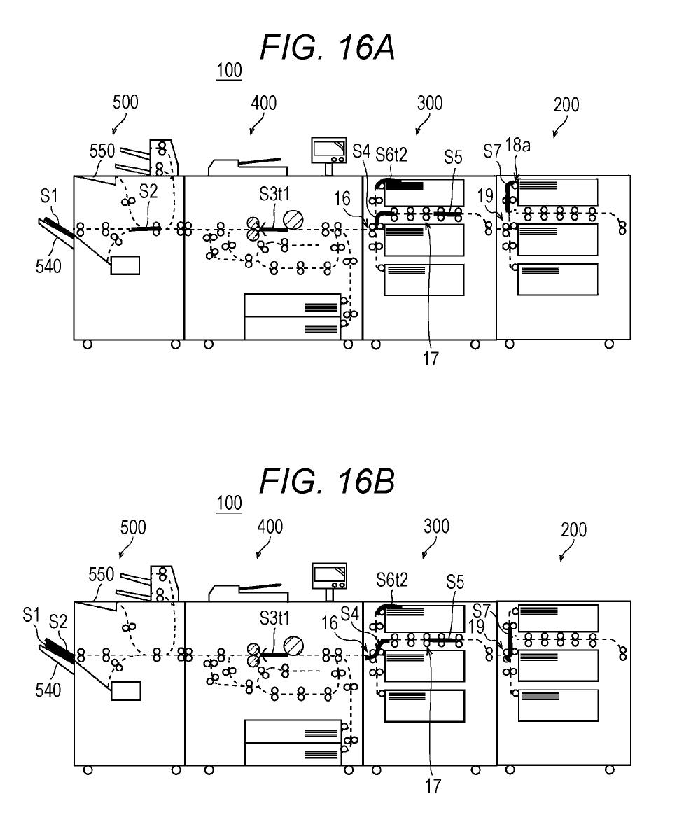

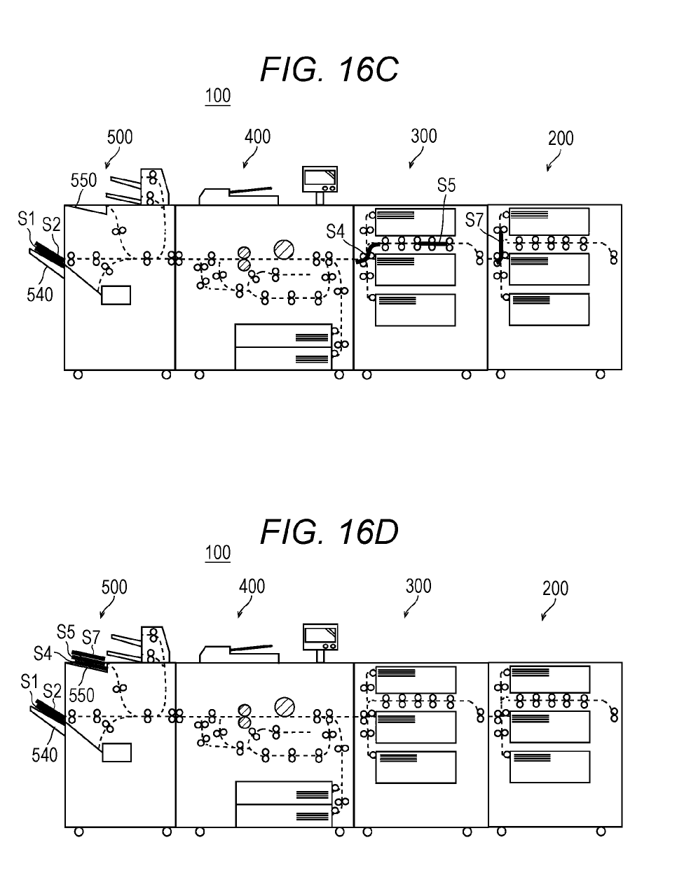

FIG. 16A is a schematic diagram exemplarily illustrating positions of sheets at the time of occurrence of a jam in the eighth example, and FIG. 16B is a schematic diagram exemplarily illustrating positions of sheets after stop processing in the eighth example. Further, FIG. 16C is a schematic diagram exemplarily illustrating positions of sheets after a jammed sheet and a first residual sheet are removed in the eighth example, and FIG. 16D is a schematic diagram exemplarily illustrating positions of sheets after the fourth automatic purge processing is performed in the eighth example.

As illustrated in FIG. 16A, assuming a case in which an A4-size sheet is supplied from the first sheet feeding apparatus 200 and a tab sheet is supplied from the second sheet feeding apparatus to the image forming apparatus 400, and the tab sheet S3t1 has caused a jam while the single-sided printing is being performed in the tab sheet insertion mode. The output order and the printing order of the sheet specified by the print job are the order of sheets S1→S2→S3t1 (first tab sheet)→S4→S5→S6t2 (second tab sheet)→S7→ . . . .

The printing of the sheet S1 has already been completed and the sheet S1 is discharged to the main tray 540 as the effective sheet. Further, since the sheet S2 is on a downstream side of the jammed sheet S3t1 at the time when the jam has occurred and printing has already been completed, the controller 490 performs control to discharge the sheet S2 to the main tray 540 as the effective sheet.

Meanwhile, the controller 490 determines whether the sheets S4 to S7 being conveyed on the conveyance path on an upstream side of the jammed sheet S3t1 at the time when the jam has occurred can be stopped at predetermined stop points so that the automatic purge processing can be performed later. In the eighth example, it is assumed that the sheets S4 to S7 can be stopped at predetermined stop points, respectively, and thus the controller 490 determines that the automatic purge processing is executable.

The controller 490 executes the stop processing for the sheets S4, S5, S6t2, and S7 to perform the automatic purge processing. Since the sheet S4 is on an upstream side of the jammed sheet S3t1 at the time when the jam has occurred and printing has not been completed, the controller 490 performs control to convey the sheet S4 to the stop point 16 (the outlet of the second sheet feeding apparatus 300). Since the sheet S5 is on an upstream side of the jammed sheet S3t1 at the time when the jam has occurred, and printing has not been completed, the controller 490 performs control to convey the sheet S5 to the stop point 17. Further, since the tab sheet S6t2 is on an upstream side of the jammed sheet at the time when the jam has occurred and printing has not been completed, the controller 490 performs control to convey the tab sheet S6t2 to the stop point 18a (the outlet of the upper tray 311). Further, since the sheet S7 is on an upstream side of the jammed sheet S3t1 at the time when the jam has occurred and printing has not been completed, the controller 490 performs control to convey the sheet S7 to the stop point 19 (the outlet of the first sheet feeding apparatus 200).

As illustrated in FIG. 16B, the sheet S2 is discharged as the effective sheet to the main tray 540 by the stop processing. Further, the sheet S5 is stopped at the stop point 17, the tab sheet S6t2 is stopped at the stop point 18a, and the sheet S7 is stopped at the stop point 19. The sheets S4, S5, S6t2, S7 are scheduled to be discharged to the outside of the image forming system 100 by the automatic purge processing after removing the jammed sheet S3t1.

Here, the tab sheets are set on the upper tray 311 of the second sheet feeding apparatus 300 in order of S9t3→S12t4→S15t5→S18t1→ . . . from the top.

However, in the case where the sheets S4, S5, S6t2, and S7 are automatically purged after the jammed sheet S3t1 is removed, there is the tab sheet S9t3 on the top of upper tray 311. Therefore, the controller 490 cannot resume the printing in the order of the sheets S3t1→S4→S5→S6t2 in the recovery printing.

To handle the situation, prompting the user to reset the tab sheets on the upper tray 311 when the jammed sheet S3t1 is removed is conceivable. However, since the tab sheet S6t2 is placed over the upper tray 311 and the outlet of the upper tray 311, the upper tray 311 cannot be pulled out.

In the eighth example, a case in which the tab sheet S6t2 cannot be moved to the downstream stop point, and the first automatic purge processing cannot be performed for the sheet S6t2 is assumed. The controller 490 causes the display of the operation display 380 to display a message prompting the user to remove the jammed sheet S3t1 and the tab sheet S6t2.

As illustrated in FIG. 16C, the user pulls out the ADU frame 454 and removes the jammed sheet S3t1, and pulls out the upper tray 311 and removes the tab sheet S6t2.

As illustrated in FIG. 16D, the controller 490 performs the automatic purge processing (fourth automatic purge processing) for the sheets S4, S5, and S7. The sheets S4, S5, and S7 are discharged to the purge tray 550. Thereafter, the controller 490 performs the recovery printing.

The image forming system 100 of the present embodiment described above has the following effects.

In the case where the first automatic purge processing is executable, the controller 490 executes the first automatic purge processing, and conveys and discharges the first residual sheet to the sheet discharger before the jammed sheet is removed. Therefore, an increase in the number of steps of jam processing and an increase in the number of sheets that should be removed by a user in the jam processing can be suppressed while a conflict between removal of a jammed sheet and a residual sheet scheduled for automatic purge processing is avoided.

Further, in a case of performing jam processing according to a conventional processing procedure or in a case of giving priority to a decrease in time (downtime) in which the machine is stopped without performing printing, execution of the first automatic purge processing can be prohibited by setting.

As described above, in the embodiment, the image forming system of the present invention has been described. However, it goes without saying that a person skilled in the art can appropriately add, modify, and omit the present invention within the scope of the technical idea.

For example, in the above embodiment, as the residual sheet in the guillotine state, the case where the residual sheet is stopped over the conveyance path inside and outside the ADU frame, and the case where the residual sheet is stopped over the outlets of the upper trays of the first and second sheet feeding apparatuses have been described. However, the present invention is not limited to the residual sheets stopped over the conveyance path inside and outside the ADU frame and over the outlets of the upper trays of the first and second sheet feeding apparatuses, and can be applied to the residual sheet at another position on the conveyance path in the image forming system.

Further, in the above embodiment, the configuration to discharge the effective sheet to the main tray and discharge the ineffective sheet to the purge tray has been described. However, the present invention is not limited to the configuration and can have a configuration to discharge the effective sheet and the ineffective sheet to the same sheet discharge tray.

Further, the control programs of the apparatuses may be provided with a computer readable recording medium such as a USB memory, a flexible disk, or a CD-ROM, or may be provided online via a network such as the Internet. In this case, the program recorded in the computer-readable recording medium is usually transferred to and stored in a memory, a storage, or the like. Further, this control program may be provided, for example, as single application software, or may be incorporated into software of the apparatuses as a function of the image forming system.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming system comprising:
a sheet conveyor including a conveyance path and which conveys a sheet along the conveyance path;
an image former provided on the conveyance path and which forms an image on the sheet;
a sheet discharger provided on a downstream side in a sheet conveyance direction of the image former and which discharges the sheet to an outside; and
a hardware processor that determines, in a case where abnormality occurs in sheet conveyance on the conveyance path, after stop processing of stopping sheets other than a jammed sheet at predetermined stop points according to conveyance positions at the occurrence of the abnormality, the jammed sheet being a cause of the abnormality in the conveyance path, is executed, whether a first residual sheet that needs to be moved before the jammed sheet is removed is included in a plurality of the sheets stopped at the stop points, and
executes first automatic purge processing of conveying and discharging the first residual sheet to the sheet discharger before the jammed sheet is removed, and second automatic purge processing of discharging a second residual sheet different from the first residual sheet, of the sheets stopped at the stop points, to the sheet discharger, after the jammed sheet is removed, according to a determination result of the hardware processor.

2. The image forming system according to claim 1, wherein
the hardware processor
determines that a sheet stopped at the stop point corresponding to a position of the jammed sheet corresponds to the first residual sheet.

3. The image forming system according to claim 1, wherein
the hardware processor
determines that a sheet stopped at the stop point where the sheet becomes an obstacle when a user removes the jammed sheet corresponds to the first residual sheet, and
the hardware processor executes the first automatic purge processing for the first residual sheet.

4. The image forming system according to claim 1, wherein
the hardware processor
determines that a sheet for which order to be discharged to the sheet discharger is determined in advance, and stopped at the stop point where the sheet becomes an obstacle to insertion and removal of a sheet feed tray that has supplied the sheet corresponds to the first residual sheet, and
the hardware processor executes the first automatic purge processing for the first residual sheet.

5. The image forming system according to claim 1, wherein,
in a case where the first residual sheet is stoppable at another stop point on a downstream side of the stop point in the stop processing,
the hardware processor
conveys the first residual sheet to the other stop point and stops the first residual sheet without executing the first automatic purge processing, and
performs control to execute third automatic purge processing of discharging the first residual sheet and the second residual sheet to the sheet discharger after the jammed sheet is removed.

6. The image forming system according to claim 1, wherein
the hardware processor
determines executability of the first automatic purge processing, and in a case of determining that the first automatic purge processing is not executable,
performs control to execute fourth automatic purge processing of discharging the second residual sheet to the sheet discharger after the jammed sheet and the first residual sheet are removed by the user, without executing the first automatic purge processing.

7. The image forming system according to claim 6, wherein
the hardware processor
determines that the first automatic purge processing is not executable
in a case where a conveyance path for executing the first automatic purge processing does not exist, or
in a case where execution of the first automatic purge processing is prohibited.

8. The image forming system according to claim 1, wherein
the sheet discharger
includes a plurality of sheet discharge trays, and discharges the first and second residual sheets to a sheet discharge tray different from a sheet discharge tray to which an effective sheet is discharged.

9. The image forming system according to claim 8, wherein the first and second residual sheets are discharged to a same sheet discharge tray.

10. A method of controlling an image forming system including
a sheet conveyor including a conveyance path and which conveys a sheet along the conveyance path,
an image former provided on the conveyance path and which forms an image on the sheet, and
a sheet discharger provided on a downstream side in a sheet conveyance direction of the image former and which discharges the sheet to an outside,
the method comprising:
(a) determining, in a case where abnormality occurs in sheet conveyance on the conveyance path, after stop processing of stopping sheets other than a jammed sheet at predetermined stop points according to conveyance positions at the occurrence of the abnormality, the jammed sheet being a cause of the abnormality in the conveyance path, is executed, whether a first residual sheet that needs to be moved before the jammed sheet is removed is included in a plurality of the sheets stopped at the stop points; and
(b) executing first automatic purge processing of conveying and discharging the first residual sheet to the sheet discharger before the jammed sheet is removed, and second automatic purge processing of discharging a second residual sheet different from the first residual sheet, of the sheets stopped at the stop points, to the sheet discharger, after the jammed sheet is removed, according to a determination result of (a).

11. A non-transitory recording medium storing a computer readable program for causing a computer to execute the method of controlling the image forming system according to claim 10.
